(19) United States
(12) Patent Application Publication
(10) Pub. No.: US 2025/0242250 A1
(43) Pub. Date: Jul. 31, 2025

(54) ONE OR MORE NON-TRANSITORY COMPUTER-READABLE MEDIA, INFORMATION PROCESSING SYSTEM, INFORMATION PROCESSING APPARATUS, AND INFORMATION PROCESSING METHOD

(71) Applicant: NINTENDO CO., LTD., Kyoto (JP)

(72) Inventors: Hiroyuki SASAKI, Kyoto (JP); Yosuke MORI, Kyoto (JP); Tatsuya KURIHARA, Kyoto (JP)

(21) Appl. No.: 19/005,971

(22) Filed: Dec. 30, 2024

(30) Foreign Application Priority Data
Jan. 30, 2024 (JP) 2024-011600

(51) Int. Cl. A63F 13/55; G06T 15/00

(52) U.S. Cl. CPC A63F 13/55; G06T 15/005

(57) ABSTRACT

If a destruction action of a player character hits a terrain object, an example of an information processing system updates a voxel value of a voxel included in a destruction range, thereby deforming a terrain polygon mesh. The information processing system projects a trace polygon mesh onto the terrain polygon mesh at a place hit by the destruction action, and sets coordinates of a vertex that can be projected onto the terrain polygon mesh based on a position onto which the trace polygon mesh is projected and also sets a vertex that cannot be projected onto the terrain polygon mesh not to be displayed.

### CROSS REFERENCE TO RELATED APPLICATION

This application claims priority to Japanese Patent Application No. 2024-011600 filed on Jan. 30, 2024, the entire contents of which are incorporated herein by reference.

### FIELD

The present disclosure relates to a non-transitory computer-readable storage medium having stored therein a game program, an information processing system, an information processing apparatus, and an information processing method that are capable of executing a game using a terrain.

### BACKGROUND AND SUMMARY

For example, there is a game where a polygon of a ski track is generated when a character plays skiing, and a texture is stuck to the polygon, thereby drawing the trajectory of the ski track.

In the above game, however, it is not assumed that the ground deforms, and there is room for improvement in leaving a trajectory in a case where a terrain deforms.

Therefore, an exemplary embodiment discloses a non-transitory computer-readable storage medium having stored therein a game program, an information processing system, an information processing apparatus, and an information processing method that are capable of leaving a trace on a terrain that freely deforms.

The exemplary embodiment employs the following configurations.

One or more non-transitory computer-readable media according to the exemplary embodiment are one or more non-transitory computer-readable media having stored therein instructions that, when executed, cause one or more processors of an information processing apparatus to execute image processing including storing, in a memory, terrain volume data that is data for representing a terrain object in a virtual space, and with respect to each voxel included in a voxel space placed in the virtual space, holds a voxel value indicating a degree to which an object occupies inside of a space defined by the voxel, and terrain polygon mesh data generated based on the terrain volume data and indicating a terrain polygon mesh representing a surface of the terrain object. The image processing further includes, based on an operation input of a player, causing a player character to perform a deformation action for deforming the terrain object in the virtual space; if the deformation action hits the terrain object, updating the voxel value of a voxel included in a deformation range set based on a position hit by the deformation action, and in accordance with the update of the voxel value, updating the terrain polygon mesh data. The image processing further includes, projecting a trace polygon mesh toward the terrain polygon mesh at a place where the deformation action hits the terrain object, and regarding vertices included in the trace polygon mesh, setting coordinates of a vertex that can be projected onto the terrain polygon mesh based on a position onto which the trace polygon mesh is projected and also setting a polygon including a vertex that cannot be projected onto the terrain polygon mesh not to be displayed, thereby placing the trace polygon mesh on the terrain polygon mesh. Then, the image processing further includes generating an image of the virtual space by a drawing process including drawing of the terrain polygon mesh or a display terrain polygon mesh generated separately from the terrain polygon mesh and for displaying the surface of the terrain object, and drawing of the trace polygon mesh using a trace texture representing a trace of the deformation action.

Based on the above, if a deformation action hits a terrain object, a trace polygon mesh is projected onto a terrain polygon mesh at the place where the deformation action hits the terrain object, and the coordinates of a vertex that can be projected are set based on the position onto which the trace polygon mesh is projected, and a vertex that cannot be projected is hidden. Consequently, it is possible to place the trace polygon mesh on the terrain object by a simple method and leave the trace of the deformation action on the terrain object.

In the above configuration, the deformation action may be a destruction action for destroying the terrain object. The image processing may further include, if the destruction action hits the terrain object, updating the voxel value of a voxel included in the deformation range to a value indicating that the terrain object is not present.

Based on the above, it is possible to destroy the terrain object by a destruction action and leave the trace of the destruction action on the terrain object.

In the above configuration, the destruction action may be an action performed toward a specified direction from the player character. The image processing may further include projecting the trace polygon mesh from a start position based on a position of the player character in a direction in which the destruction action is performed, thereby performing the projection at a place hit by the destruction action.

Based on the above, it is possible to perform the destruction action from the position of a player character in a specified direction and place the trace polygon mesh on the terrain object in accordance with the position of the player character and the direction of the destruction action.

In the above configuration, the image processing may further include, in the drawing of the trace polygon mesh, not drawing a portion where the terrain object is not present in a predetermined range on a far side of the trace polygon mesh, and drawing a portion where the terrain object is present in the predetermined range.

Based on the above, in a drawing process for drawing the trace polygon mesh, a portion where the terrain object is present in a predetermined range on a far side of the trace polygon mesh is drawn, whereby it is possible to leave the trace of a part and hide the trace of another part.

In the above configuration, the image processing may further include, if the destruction action is further performed on the terrain object on which the trace polygon mesh is placed, projecting the trace polygon mesh toward the terrain polygon mesh again, and setting coordinates of a vertex that can be projected onto the terrain polygon mesh based on a position onto which the trace polygon mesh is projected and also setting a polygon including a vertex that cannot be projected onto the terrain polygon mesh not to be displayed, thereby placing the trace polygon mesh on the terrain polygon mesh.

Based on the above, if the destruction action is further performed on the terrain object on which the trace polygon mesh is placed, a similar projection process is performed again, whereby it is possible to leave the trace on the terrain object that is destroyed.

In the above configuration, the image processing may further include, among the vertices included in the trace polygon mesh, setting an opacity of a vertex in contact with the polygon set not to be displayed so that the opacity is lower than an opacity of another vertex that can be projected onto the terrain polygon mesh.

Based on the above, the opacity of a vertex in contact with a polygon set not to be displayed is made low, whereby it is possible to make a vertex near a vertex that cannot be projected onto the terrain object translucent. Consequently, it is possible to make the boundary of the trace displayed on the terrain object natural.

In the above configuration, the image processing may further include, based on the voxel value, generating the terrain polygon mesh by an algorithm for placing a polygon so that a vertex position of the terrain polygon mesh is determined between a voxel in which the terrain object is not present and a voxel in which the terrain object is present, and based on the hit of the deformation action, recalculating a vertex position of the terrain polygon mesh in a range at least including a voxel the voxel value of which is updated.

Based on the above, if a voxel value is updated, it is possible to update the terrain polygon mesh and easily deform the terrain object.

One or more non-transitory computer-readable media according to another exemplary embodiment are one or more non-transitory computer-readable media having stored therein instructions that, when executed, cause one or more processors of an information processing apparatus to execute image processing including storing, in a memory, terrain polygon mesh data indicating a terrain polygon mesh representing a surface of a terrain object in a virtual space. The image processing further includes causing a deformation event where the terrain object is deformed in the virtual space to occur; and based on the occurrence of the deformation event, deforming the terrain polygon mesh. The image processing further includes projecting a trace polygon mesh toward the terrain polygon mesh at a place where the deformation event occurs, and regarding vertices included in the trace polygon mesh, setting coordinates of a vertex that can be projected onto the terrain polygon mesh based on a position onto which the trace polygon mesh is projected and also setting a polygon including a vertex that cannot be projected onto the terrain polygon mesh not to be displayed, thereby placing the trace polygon mesh on the terrain polygon mesh. Then, the image processing also further includes generating an image of the virtual space by a drawing process including drawing of the terrain polygon mesh or a display terrain polygon mesh generated separately from the terrain polygon mesh and for displaying the surface of the terrain object, and drawing of the trace polygon mesh using a trace texture representing a trace of the deformation event.

Based on the above, if a deformation event occurs, a trace polygon mesh is projected onto a terrain polygon mesh at the place where the deformation event occurs, and the coordinates of a vertex that can be projected are set based on the position onto which the trace polygon mesh is projected, and a vertex that cannot be projected is hidden. Consequently, it is possible to place the trace polygon mesh on the terrain object by a simple method and leave the trace of the deformation event on the terrain object.

In the above configuration, the image processing may further include, if the deformation event occurs again in the terrain object on which the trace polygon mesh is placed, deforming the terrain polygon mesh, leaving a portion of the trace polygon mesh relating to a portion of the terrain polygon mesh that is not deformed, and controlling a portion of the trace polygon mesh relating to the deformed portion of the terrain polygon mesh not to be displayed.

Based on the above, if the deformation event occurs again on the terrain object on which the trace polygon mesh is placed, it is possible to deform the terrain polygon mesh and also leave the trace in a portion of the terrain polygon mesh that is not deformed.

Another exemplary embodiment may be an information processing system that executes the above game program, or may be an information processing apparatus, or may be an information processing method.

According to the exemplary embodiment, it is possible to place a trace polygon mesh on a terrain object by a simple method, and for example, leave the trace of a deformation action on the terrain object.

These and other features, aspects and advantages of the subject matter described herein will become more apparent from the following detailed description of the exemplary embodiments when taken in conjunction with the accompanying drawings.

### BRIEF DESCRIPTION OF THE DRAWINGS

FIG. 1 is an illustrative non-limiting diagram showing an example of the game system;

FIG. 2 is an illustrative non-limiting block diagram showing an example of the internal configuration of the main body apparatus 2;

FIG. 3 is an illustrative non-limiting block diagram showing an example of the internal configurations of the main body apparatus 2, the left controller 3, and the right controller 4;

FIG. 4 is an example non-limiting diagram showing an example of a terrain object as a voxel object;

FIG. 5 is an example non-limiting diagram showing examples of the states before and after a part of the terrain object shown in FIG. 4 is deleted;

FIG. 6 is an example non-limiting diagram showing examples of the states before and after a part of the terrain object shown in FIG. 4 is deleted;

FIG. 7 is an example non-limiting diagram showing an example of the content of voxel data;

FIG. 8 is an example non-limiting diagram showing an example of property information indicating the property of a material;

FIG. 9 is an example non-limiting diagram showing an example of texture information indicating the texture of a material;

FIG. 10 is an example non-limiting diagram showing an example of a method for generating a mesh;

FIG. 11 is an example non-limiting diagram showing an example of a game image including a terrain object;

FIG. 12 is an example non-limiting diagram showing an example of a game image in a case where a player character PC performs a destruction action on a terrain object TO;

FIG. 13 is an example non-limiting diagram showing an example of a game image after the destruction action hits the terrain object TO;

FIG. 14 is an example non-limiting diagram showing an example of a game image when the destruction action further hits the terrain object TO in the state of FIG. 13;

FIG. 15 is an example non-limiting diagram illustrating a method for adding a trace tr onto a terrain object TOJ;

FIG. 16 is an example non-limiting diagram showing an example of the state where a trace polygon mesh trpm is projected onto the terrain object TOJ;

FIG. 17 is an example non-limiting diagram showing an example of a vertex Vtf that cannot be projected onto the terrain object TOJ;

FIG. 18 is an example non-limiting diagram showing an example of the trace polygon mesh trpm before and after unnecessary vertices are eliminated in a case where the trace polygon mesh trpm is projected onto the terrain object TOJ;

FIG. 19 is an example non-limiting diagram showing the state where another terrain object TOJ is placed on the terrain object TO, and the player character PC performs the destruction action on the terrain object TOJ;

FIG. 20 is an example non-limiting diagram showing the state before the destruction action is performed on the terrain object TOJ on which the trace polygon mesh trpm is placed;

FIG. 21 is an example non-limiting diagram showing the state after the destruction action is performed on the terrain object on which the trace polygon mesh trpm is placed;

FIG. 22 is an example non-limiting diagram showing examples of various pieces of data used in game processing by a game system 1;

FIG. 23 is an example non-limiting flow chart showing an example of the flow of game processing executed by the game system 1;

FIG. 24 is an example non-limiting flow chart showing an example of a destruction action process in step S5; and

FIG. 25 is an example non-limiting flow chart showing an example of a trace process in step S25.

### DETAILED DESCRIPTION OF NON-LIMITING EXAMPLE EMBODIMENTS

### 1. Configuration of Game System

A game system according to an example of an exemplary embodiment is described below. FIG. 1 is a diagram showing an example of the game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus that executes various processes (e.g., game processing) in the game system 1. The left controller 3 and the right controller 4 are apparatuses including an operation section for a user to provide an input.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies. It should be noted that hereinafter, the left controller 3 and the right controller 4 will occasionally be referred to collectively as a “controller”.

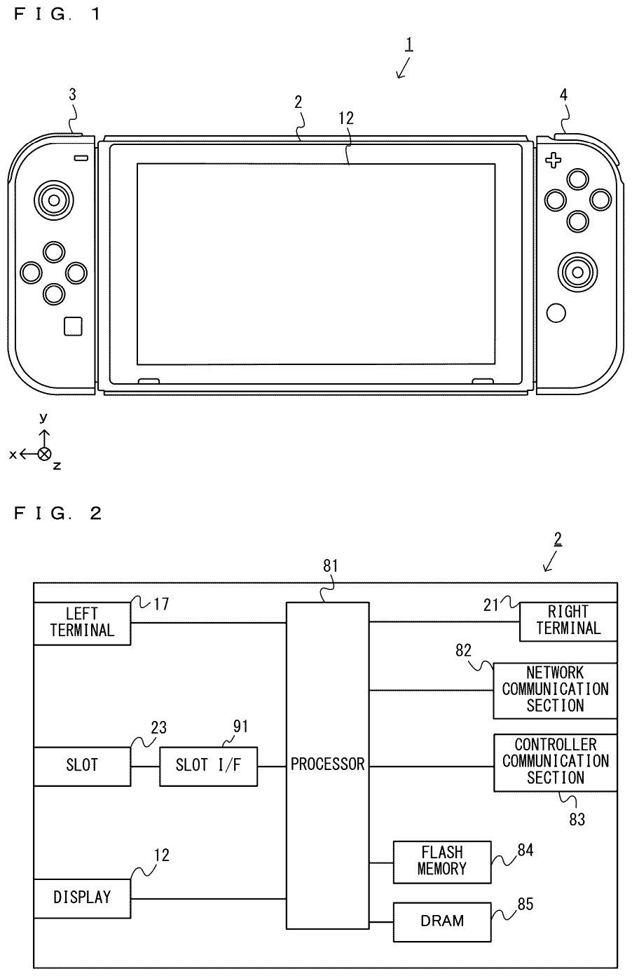

FIG. 2 is a block diagram showing an example of the internal configuration of the main body apparatus 2. The main body apparatus 2 includes components 17, 21, 23, 81 to 85, and 91 shown in FIG. 2 in addition to the components shown in FIG. 1. Some of the components 17, 21, 23, 81 to 85, and 91 may be mounted as electronic components on an electronic circuit board and accommodated in a housing 11.

The main body apparatus 2 includes the display 12. The display 12 displays an image generated by the main body apparatus 2. In the exemplary embodiment, the display 12 is a liquid crystal display device (LCD). The display 12, however, may be a display device of any type.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) or other instructions that are stored in storage. For example, in an internal non-transitory storage medium such as a flash memory 84, an external storage non-transitory medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. DRAM 85 and flash memory 84 are illustrative non-limiting examples of non-transitory computer-readable media.

The main body apparatus 2 includes a slot 23. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17 and the right terminal 21. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. As described above, in the exemplary embodiment, the main body apparatus 2 can perform both wired communication and wireless communication with each of the left controller 3 and the right controller 4.

Further, the display 12 is connected to the processor 81. The processor 81 displays a generated image (e.g., an image generated by executing the above information processing) and/or an externally acquired image on the display 12.

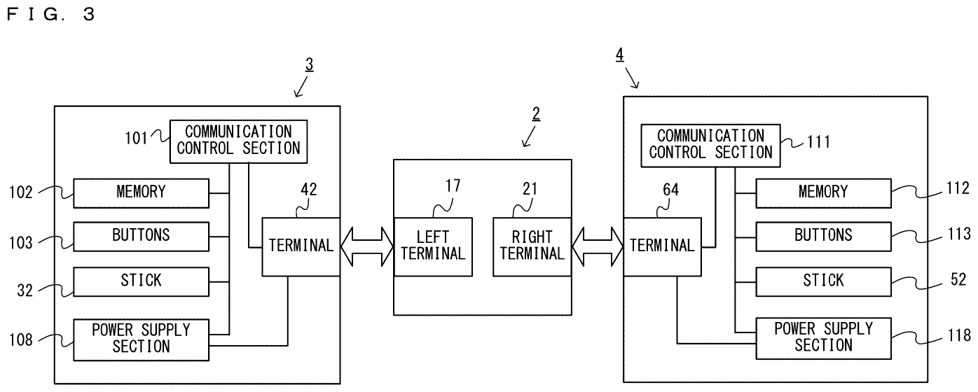

FIG. 3 is a block diagram showing examples of the internal configurations of the main body apparatus 2, the left controller 3, and the right controller 4. It should be noted that the details of the internal configuration of the main body apparatus 2 are shown in FIG. 2 and therefore are omitted in FIG. 3.

The left controller 3 includes a terminal 42 for the left controller 3 to perform wired communication with the main body apparatus 2. The left controller 3 includes a communication control section 101, which communicates with the main body apparatus 2. As shown in FIG. 3, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83).

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103. Further, the left controller 3 includes the analog stick (“stick” in FIG. 3) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine the operation of moving the left controller 3 and operations on the buttons 103 and the analog stick 32 based on the operation data.

The left controller 3 includes a power supply section 108. In the exemplary embodiment, the power supply section 108 includes a battery and a power control circuit. Although not shown in FIG. 3, the power control circuit is connected to the battery and also connected to components of the left controller 3 (specifically, components that receive power supplied from the battery).

As shown in FIG. 3, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### 2. Outline of Process on Game System

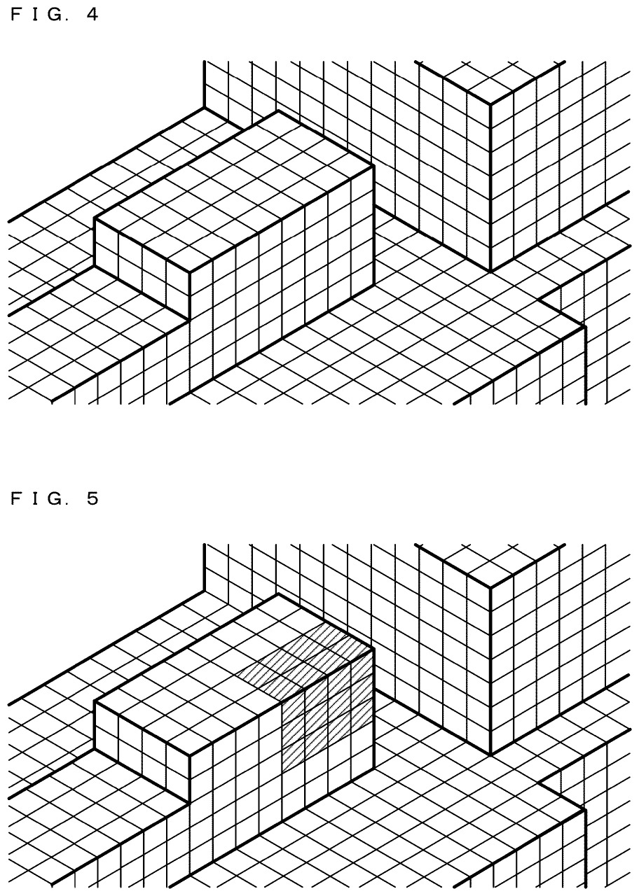

Next, referring to FIG. 4 to FIG. 11, an outline of the process performed on the game system 1 will be described. In the present embodiment, the game system 1 generates a game image in which terrain objects and characters (e.g., the player character controlled by the player) are arranged in a game space, which is a three-dimensional virtual space, and displays the game image on a display device. Note that in the present embodiment, the display device on which the game image is displayed may be the display 12 described above, or may be a monitor. The monitor may be stationary or may be movable.

### [2-1. Voxel]

In the present embodiment, for some objects in the game space, the shape is defined by voxel data. Here, voxels are rectangular parallelepiped (more specifically, cubic) regions arranged in a grid pattern in the game space, and voxel data is data that is set for each voxel. Hereinafter, an object whose shape is defined by voxel data will be referred to as a “voxel object”. In the present embodiment, for each of a plurality of voxels that are set in the game space, the game system 1 stores voxel data as data for generating voxel objects in the game space.

FIG. 4 is a view showing an example of a terrain object, which is a voxel object. As shown in FIG. 4, in the present embodiment, a terrain object representing a terrain such as a ground surface has its shape defined by voxel data. The cubes shown in FIG. 4 represent a terrain object. Note that in FIG. 4, edges of the terrain object are indicated by thick lines. However, these thick lines are added for the purpose of making the drawings easier to understand, and in practice, there is no need for edges of the terrain object to be drawn thick.

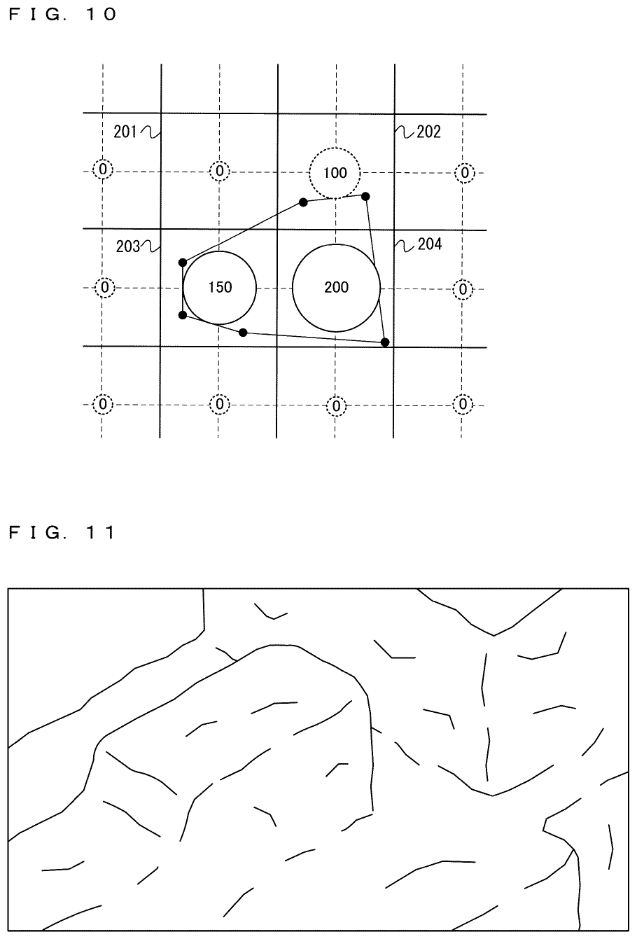

For example, the terrain object shown in FIG. 4 is generated by the following rule: “a cube is placed at the position of a voxel if a parameter included in the voxel data set for the voxel is greater than a predetermined value, and nothing is placed at the position of the voxel if the parameter is less than or equal to the predetermined value”. The terrain object in FIG. 4 is shown for the purpose of illustrating the relationship between voxels and voxel objects in an easy-to-understand manner. In the present embodiment, in practice, a voxel object is generated by such a rule that results in a terrain object having a complicated shape in comparison with the cubic voxels (e.g., based on the voxel data), such as a terrain object shown in FIG. 10 to be described below, for example. Note that there is no limitation on the rule for determining the shape of the voxel object based on the voxel data. In other embodiments, the game system 1 may generate a voxel object as shown in FIG. 4 based on the voxel data or may generate a voxel object as shown in FIG. 11 based on the voxel data.

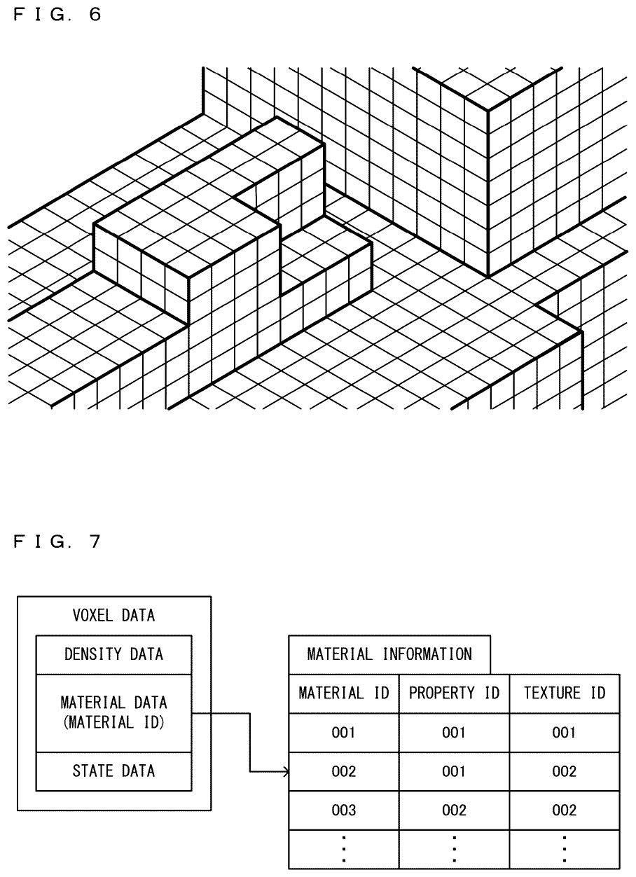

It is possible to change the shape of a voxel object by changing voxel data of voxels. FIG. 5 and FIG. 6 are views showing before and after the deletion of a portion of the terrain object shown in FIG. 4. That is, when the hatched portion of the terrain object shown in FIG. 5 is destroyed, the terrain object changes to a shape as shown in FIG. 6. In such a case, the game system 1 can easily delete the terrain object by rewriting the voxel data described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, in a case where the shape of a terrain object may be changed as a result of the terrain object in a game being broken for some reason (e.g., the player object striking the terrain object), the game system 1 can freely change the shape of the terrain object by changing the voxel data used to generate the terrain object, rather than directly changing data representing the outer shape of the terrain object (e.g., the mesh to be described below).

FIG. 7 is a diagram showing an example of content of voxel data. Here, in the present embodiment, the game space can be divided into a plurality of voxels arranged in a grid pattern. The game system 1 stores voxel data for each voxel in the game space so that the voxel data is associated with the voxel. The voxel data represents, for example, the presence/absence of a voxel object in the voxel corresponding to the voxel data.

As shown in FIG. 7, voxel data includes density data. The density data is data of a density indicating the degree to which an object is included in the region defined by each voxel. As will be described in detail below, the position and the shape of the surface of the voxel object (e.g., the mesh to be described below) are determined based on this density. In other words, in the present embodiment, this density is also data used to generate a mesh that defines the surface of the voxel object.

In the present embodiment, the density can take an integer value in the range from the lower limit value (e.g., 0) to the upper limit value (e.g., 255). In the present embodiment, in the game system 1, when the density value set for the voxel is high, the proportion of the volume to be occupied by the voxel object in the voxel is high. When the density value is low, the proportion is low. For example, if the density is 0, there is no object in the voxel, if the density is 255, the inside of the voxel is entirely the object, and if the density is between 0 and 255, the inside of the voxel is occupied by the object to the proportion that is determined based on the density value. Then, the shape of the voxel mesh, e.g., the shape of the voxel object, is determined based on the density. Note however that the shape of the voxel object generated based on the density does not need to have a volume that exactly matches the proportion represented by the density. For example, there is a case where the method of generating a voxel object as shown in FIG. 4 and the method of generating a voxel object as shown in FIG. 11 differ in volume, even if they are based on the same density.

In other embodiments, the density may indicate either a state in which the voxel object occupies the entirety of the region within the voxel or a state in which no voxel object is included in the region within the voxel. For example, the density data may be data that can take only either 0 or 1.

As shown in FIG. 7, voxel data includes material data. The material data represents the material (in other words, the substance) of the voxel object generated by the voxel data. Here, in the present embodiment, materials such as sand, rock and soil, for example, are set for voxel objects. That is, in the present embodiment, a plurality of types of materials are provided as materials that can be set for a voxel object, and one of the materials is set for a voxel object.

As shown in FIG. 7, in the present embodiment, the material data represents the identification information of the material (referred to as “material ID”). In the present embodiment, the game system 1 stores material information representing the property and the texture of the material for each material provided in the game. In the present embodiment, the material information represents associations between the material ID, the property of the material and the appearance (specifically, the texture) of the material. Specifically, the material information is information that represents associations between the material ID, identification information of the property of the material (referred to as “property ID”) and identification information of the texture of the material (referred to as “texture ID”) (see FIG. 7).

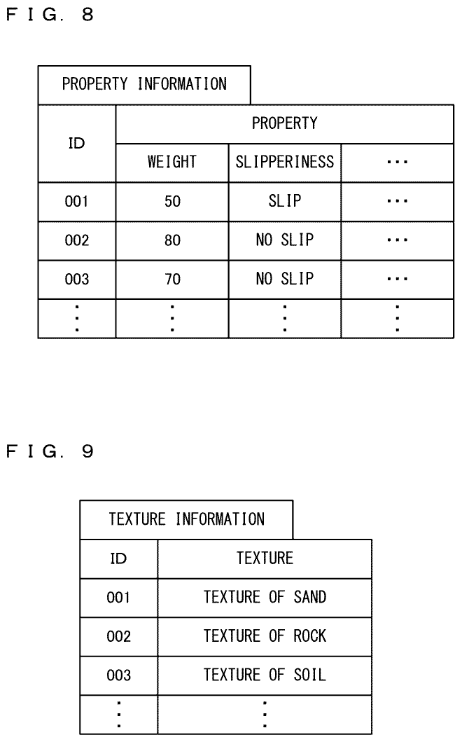

FIG. 8 is a diagram showing an example of property information representing properties of materials. As shown in FIG. 8, the game system 1 stores property information that associates each property ID with information that represents the content of the property represented by the property ID. A property of a material is a property of a voxel object for which the material is set in the game, and it may be information such as weight or slipperiness shown in FIG. 8, for example. Note that the specific content of the property is optional, and for example, the following information may be set as properties of a material.
Temperature
Breakability (e.g., the number of times of impact impartation needed to break a voxel object)
Whether another object can be bonded to a voxel object
Amount of hit points to be regained by the player character when the player character breaks a voxel object
Amount of in-game currency to be gained by the player character when the player character breaks a voxel object

Note that there is no limitation on the specific content of the property to be set for a material. In other embodiments, information different from those listed above may be set as information that represents a property of a material.

FIG. 9 is a diagram showing an example of texture information representing textures of materials. As shown in FIG. 9, the game system 1 stores texture information that associates the texture ID with the texture represented by the texture ID.

Note that in addition to information of texture, any information regarding the color and/or pattern may be set as data that defines the appearance of a voxel object. For example, a pattern of cracks may be set as information regarding the appearance of a voxel object. By using such a pattern, the game system 1 can generate an image of a voxel object that represents the appearance of cracks.

As described above, in the present embodiment, the material data defines, by the material ID, the property of the voxel object and the texture used for the voxel object. For example, when the material ID represented by the material data included in the voxel data is “002”, the property represented by the property ID “001” that is associated with the material ID in the material information is set as the property of the voxel object corresponding to the voxel data (see arrow shown in FIG. 7). In this case, the texture that is represented by the texture ID “002” associated with the material ID in the material information is applied to the voxel object corresponding to the voxel data (see arrow shown in FIG. 7).

As described above, in the present embodiment, the game system 1 separately manages the property and the texture of the material. Therefore, in the present embodiment, it is possible to easily set a plurality of types of materials having the same property but having different appearances (e.g., different textures) or set a plurality of types of materials having different properties but having the same appearance.

Note that the material data may be any data with which it is possible to identify the property and/or the texture of the material. For example, in other embodiments, the material data may represent the property ID and the texture ID, or may have a data structure that actually includes data representing the property and the texture of the material.

The material data may further represent information related to the material other than the property and the texture described above. For example, the material data may include special effect data that represents the special effect to be triggered upon satisfaction of a special effect triggering condition set for the voxel object (e.g., a portion of the voxel object being broken, or the character stepping on the voxel object). Note that the special effect data may be data that represents a special effect image (e.g., a special effect image showing the voxel object being broken), or may be data that represents a special effect sound (a sound of footstep when the character walks on the voxel object).

As shown in FIG. 7, the voxel data includes state data that represents the state of the voxel object. There is no limitation on the specific content of the state data. For example, the state data may be data that represents whether the voxel object is in a wet state, or may be data that represents the amount of damage applied to the voxel object. The content of the state data may be updated during the game.

### [2-2. Mesh]

In the present embodiment, the surface of the voxel object is represented by a mesh. A mesh is a set of faces (specifically, polygons) placed in the game space. In the present embodiment, the game system 1 generates a mesh for the voxel object based on the voxel data of each voxel set in the game space. An example of how a mesh is generated based on voxel data will now be described.

FIG. 10 is a diagram showing an example method for generating a mesh. Note that in FIG. 10, voxels and meshes are represented in two dimensions for the purpose of making the drawing easier to understand and for the sake of discussion, but in practice, a three-dimensional mesh is generated based on voxels in a three-dimensional space.

As described above, in the present embodiment, the density set for a voxel is in the range of 0 to 255. In the present embodiment, voxels with densities equal to or greater than the reference value are considered to be inside the voxel object, and voxels with densities less than the reference value are considered to be outside the voxel object. It is not necessary to define only voxels with a density of 0 as being outside the voxel object (e.g., reference value=1), and the reference value may be set to 128, for example. In the example shown in FIG. 10, a voxel 201 and the other outer voxels have a density of 0, a voxel 202 has a density of 100, which is less than the reference value, and voxels 203 and 204 have densities of 150 and 200, which are greater than the reference value (e.g., 128). In the present embodiment, the game system 1 generates vertices between those voxels whose densities are equal to or greater than the reference value and those voxels whose densities are less than the reference value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference value and a voxel whose density is less than the reference value. Then, a polygon mesh is generated by connecting together adjacent vertices if the connection (the boundary between the regions including the vertices) passes through a voxel whose density is equal to or greater than the reference value and a voxel whose density is less than the reference value. The coordinates of each vertex are determined by comparing densities of adjacent voxels and interpolating based on the difference in density for each of the XYZ axes. In this process, the coordinates can be further calculated based on the normal information. The normal information may be stored in advance for at least some of the voxels, or if not stored, the normal information may also be calculated based on densities between adjacent voxels. Note that in FIG. 10, the density of the voxel 202 is less than the reference value, the voxel 202 is treated as being outside the object in the determination of the presence/absence of a vertex, but the density value itself of the voxel 202 is used to calculate the coordinates of the vertices generated. If the reference value were set to a value lower than the density of the voxel 202, it would result in an increase in the vertices on the upper right side and the upper left side in the voxel 202 of FIG. 10.

By generating a polygon mesh as described above, it is possible to generate a shape whose volume is based on (e.g., reflects) the density of each voxel to some extent. Note however that depending on the relationship with neighboring voxels, it is possible that a voxel with a density of 0 may partially include a region inside the object, or a voxel with a density of 255 may partially include a region outside the object. Since voxels with densities less than the reference value are treated as being outside the object in the present embodiment, there are fewer vertices as compared with a case where those voxels are treated as being inside the object, the volume will be smaller accordingly. That is, there is no need to calculate the polygon mesh so that the volume strictly corresponds to the density value.

FIG. 11 shows an example of a game image including a terrain object. In the present embodiment, by generating a mesh as described above, the voxel object can be made in a shape with complicated irregularities compared to the cubic voxels, for example.

Note that there is no limitation on the method of generating a mesh based on voxel data. For example, in other embodiments, if the density of the voxel data is greater than a predetermined value, a mesh may be generated so that a cube is placed in the voxel corresponding to the voxel data (see FIG. 4).

For each face of the mesh generated as described above, the game system 1 determines the appearance (e.g., color and/or pattern) of each such face according to the material identified by the voxel data. Specifically, the game system 1 determines the texture to be used for rendering each face of the mesh based on the voxel data, and maps the determined texture to each face to generate an image of the voxel object. Note that the texture to be mapped to each face of the mesh is determined based on the voxel data of the voxel used to generate the face (which will be referred to as the target voxel) among the voxels where the voxel object exists. Note that the target voxel is, for example, one or more voxels located around the face, although it depends on the mesh generation method. That is, the texture mapped to a face of the mesh is determined to be a texture corresponding to the material set for one or more voxels placed around the face.

Note that in other embodiments, one voxel data may include multiple types (e.g., two types) of material data. In such a case, the voxel data includes ratio data related to the multiple types of material data. The ratio data is data for determining the texture to be used for the voxel object, and represents the ratio by which each of the materials (specifically, the texture corresponding to the material) represented by the multiple types of material data influences the appearance (specifically, the color and/or pattern) of the voxel object. When determining the texture to be mapped to each face of the mesh, the texture is determined based on various data (specifically, density data, multiple types of material data and ratio data) included in the voxel data of the target voxel. For example, when multiple types of materials are set for a target voxel corresponding to one face, a texture corresponding to the (one type of) material with the greatest degree of influence may be used while taking the ratio into consideration, or textures corresponding to multiple types of materials may be used while taking the ratio into consideration.

In other embodiments, there may be both voxel objects for which voxel data including one type of material data is used, and voxel objects for which voxel data including two types of material data is used.

### (Overview of Game Processing)

Next, a description is given of the deformation of a terrain object (a voxel object) performed in a game according to the exemplary embodiment. In the game according to the exemplary embodiment, a terrain object and a player character PC are placed in a virtual space. The terrain object is an object forming a terrain such as the ground or a mountain, and a different terrain object is placed in accordance with the scene of the game. For example, in the scene of a rock pile, an object representing a rock or soil is placed as a terrain object in the virtual space. In another scene, an object representing a grassland and objects representing a river and a lake are placed as terrain objects. In addition to these, terrain objects forming various terrains are placed in accordance with the scene of a desert, the scene of a volcano, the scene of a city, or the like. The terrain object may be an object representing an artificial structure such as a road, a bridge, or a building.

Based on an operation input of a player, the player character PC moves on the terrain object, jumps on the terrain object, or performs a deformation action on the terrain object. The deformation action is the action of deforming the terrain and is an action capable of changing a voxel value (specifically, a density) set for each voxel. In the exemplary embodiment, the player character PC performs a destruction action for destroying the terrain object as an example of the deformation action for deforming the terrain object. FIG. 12 is a diagram showing an example of a game image in a case where the player character PC performs the destruction action on a terrain object TO.

As shown in FIG. 12, in accordance with an instruction from the player, the player character PC throws a punch as an example of the destruction action. Specifically, the player character PC performs the destruction action in a direction relating to a direction input (e.g., a direction input using a stick) of the player. For example, the player character PC performs the destruction action in any of the horizontal direction, the down direction, and the up direction. As shown in FIG. 12, if the player character PC performs the destruction action toward a terrain object TO, the destruction action may hit the terrain object TO. The determination of whether or not the destruction action hits the terrain object TO is made based on the position of the player character PC, the direction of the destruction action, and a terrain polygon mesh representing the surface of the terrain object TO. If it is determined that the destruction action hits the terrain object TO, a hit position is determined. The hit position is determined based on the position of the player character PC, the direction of the destruction action, and the terrain polygon mesh.

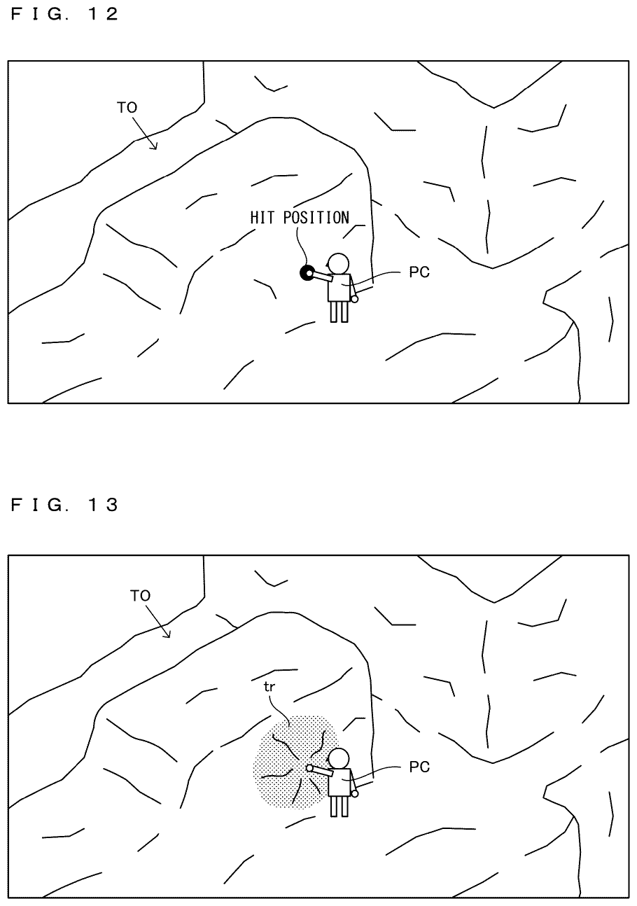

FIG. 13 is a diagram showing an example of a game image after the destruction action hits the terrain object TO. As shown in FIG. 13, if the destruction action hits the terrain object TO, a trace tr is added onto the terrain object TO at the place hit by the destruction action. The trace tr indicates that the destruction action hits the terrain object TO, and is displayed on the surface of the terrain object TO including the hit position. For example, the trace tr is an image in which the terrain object TO is cracked.

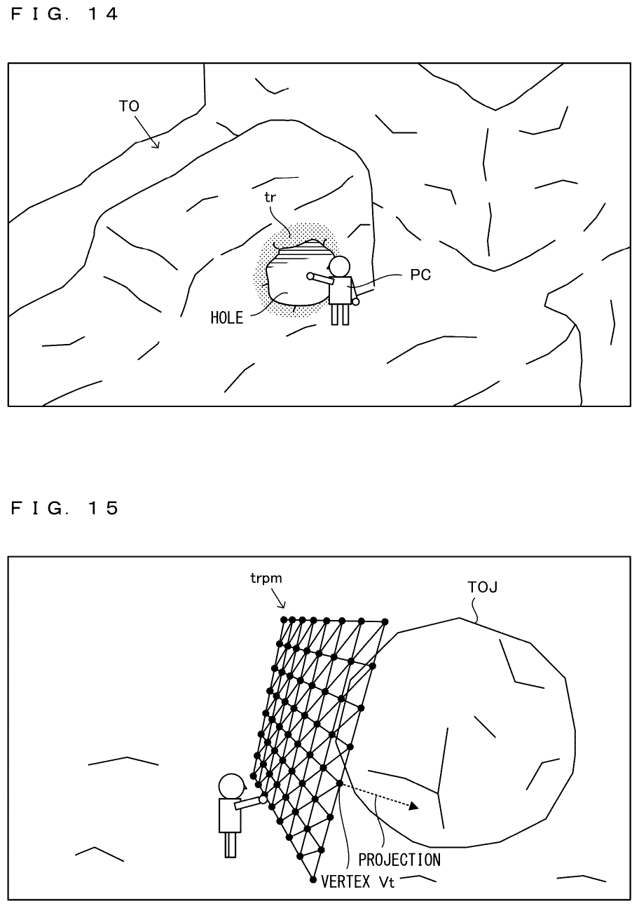

FIG. 14 is a diagram showing an example of a game image when the destruction action further hits the terrain object TO in the state of FIG. 13. As shown in FIG. 14, if the player character PC further performs the destruction action, and the destruction action hits the terrain object TO, the terrain object TO included in a predetermined destruction range including the hit position is destroyed. That is, the terrain object TO included in the destruction range ceases to be present, and a hole (a cavity) occurs in the terrain object TO. If the terrain object TO included in the destruction range is destroyed, a part of the trace tr included in the destruction range also disappears, but a part of the trace tr that is not included in the destruction range is left.

As described above, if the destruction action hits the terrain object TO, the trace tr is added to the surface of the terrain object TO. If the destruction action hits the terrain object TO, a part of the terrain object TO is destroyed.

In the above description, if the destruction action hits the terrain object TO once, the trace tr is added, and if the destruction action hits the terrain object TO once more, the terrain object TO is destroyed. This is merely an example, and the number of hit times of the destruction action until the trace tr is added and the number of hit times of the destruction action until the terrain object TO is destroyed are not limited to these. For example, if the destruction action hits the terrain object TO multiple times, the trace tr may be added, and if the destruction action hits the terrain object TO once more or multiple more times, the terrain object TO may be destroyed. If the destruction action hits the terrain object TO once or multiple times, the trace tr may be added, and the terrain object TO may also be destroyed. That is, the addition of the trace tr and the destruction of the terrain object TO may be performed at the same timing.

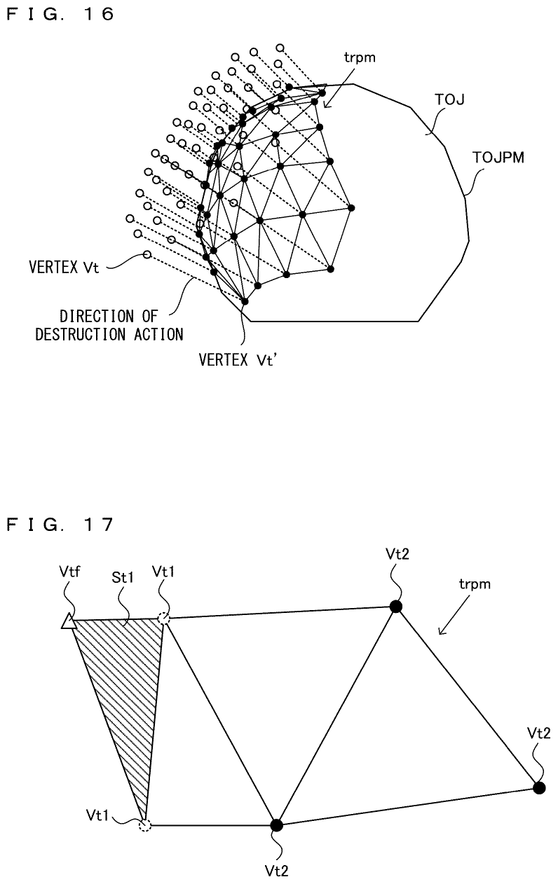

Next, a description is given of a specific method for adding the trace tr onto the terrain object. FIG. 15 is a diagram illustrating a method for adding the trace tr onto a terrain object TOJ.

As shown in FIG. 15, if the destruction action of the player character PC hits a terrain object TOJ placed in the virtual space, a trace polygon mesh trpm is placed at a start position (an initial position) based on the position of the player character PC. The trace polygon mesh trpm is used to add the trace tr onto the terrain object TOJ hit by the destruction action. The trace polygon mesh trpm is a plate-shaped object formed of a plurality of polygons including a plurality of vertices Vt. The trace polygon mesh trpm placed at the start position is deformed and placed along the surface of the terrain object TOJ. Specifically, the trace polygon mesh trpm placed at the start position is projected toward the terrain object TOJ.

FIG. 16 is a diagram showing an example of the state where the trace polygon mesh trpm is projected onto the terrain object TOJ. As shown in FIG. 16, each vertex Vt of the trace polygon mesh trpm is projected onto the surface of the terrain object TOJ (a terrain polygon mesh TOJPM representing the surface of the terrain object TOJ). In FIG. 16, a white circle indicates the vertex Vt of the trace polygon mesh trpm before the projection, and a black circle indicates a vertex Vt′ of the trace polygon mesh trpm after the projection. Each vertex Vt is projected in the direction of the destruction action. For example, a straight line parallel to the direction of the destruction action passing through the vertex Vt is projected (perform ray-casting), an intersection point between the straight line and the terrain polygon mesh TOJPM is calculated, and based on the intersection point, the coordinates of the vertex Vt′ after the projection are set. The vertex Vt′ after the projection is set at a position closer to the vertex Vt before the projection than the intersection point is. Consequently, the trace polygon mesh trpm is displayed preferentially over the terrain polygon mesh TOJPM. The vertex Vt′ after the projection may be set at the position of the intersection point.

As described above, each vertex Vt of the trace polygon mesh trpm is projected onto the terrain object TOJ, whereby the trace polygon mesh trpm is placed along the surface of the terrain object TOJ. Then, a trace texture representing the trace of the destruction action (e.g., an image representing a cracked rock) is applied to the trace polygon mesh trpm. Consequently, it is possible to display the state where the trace tr indicating that the destruction action hits the terrain object TOJ is left, and a rock is cracked by the destruction action.

Here, there is a case where the vertex Vt of the trace polygon mesh trpm cannot be projected onto the terrain object TOJ. For example, if the straight line parallel to the direction of the destruction action passing through the vertex Vt does not intersect the terrain polygon mesh TOJPM, the vertex Vt cannot be projected onto the terrain object TOJ. Such a vertex Vt is eliminated as an unnecessary vertex.

FIG. 17 is a diagram showing an example of a vertex Vtf that cannot be projected onto the terrain object TOJ. In FIG. 17, a white triangle indicates the vertex Vtf that cannot be projected onto the terrain object TOJ. A black circle indicates a vertex Vt2 that can be projected onto the terrain object TOJ. A white circle indicates a vertex Vt1 that can be projected onto the terrain object TOJ and is in contact with a polygon St1 including the vertex Vtf. As shown in FIG. 17, if, among the plurality of vertices Vt of the trace polygon mesh trpm, the vertex Vtf cannot be projected onto the terrain object TOJ, the vertex Vtf is eliminated as an unnecessary vertex from display targets. The polygon St1 including the eliminated vertex Vtf is also eliminated as an unnecessary polygon from display targets. The vertex Vt1 in contact with the polygon St1 is made translucent. Other vertices Vt2 that can be projected onto the terrain object TOJ are set to be displayed.

For example, the opacity of the vertex Vtf that cannot be projected onto the terrain object TOJ is set to “0” so that the vertex Vtf is not displayed. The vertex Vtf may be set not to be connected to another vertex. Consequently, the polygon St1 including the vertex Vtf is not displayed as a part of the trace tr. The opacity of the vertex Vt1 in contact with the polygon St1 is reduced compared to that of the vertex Vt2. The opacity of the vertex Vt2 is set to a predetermined value (e.g., a maximum value). As described above, it is possible to hide the vertex Vtf that cannot be projected onto the terrain object TOJ, display the vertex Vt2 that can be projected onto the terrain object TOJ, and make the vertex Vt1 between the vertices Vtf and Vt2 translucent. Consequently, it is possible to leave the trace tr only on the terrain object TOJ hit by the destruction action. The opacity of the vertex Vt1 is reduced, whereby it is possible to make the contour of the trace tr ambiguous and display a natural trace without discomfort.

The vertex Vtf that cannot be projected onto the terrain object TOJ may be deleted from the trace polygon mesh trpm. That is, position information regarding the vertex Vtf that cannot be projected onto the terrain object TOJ may be deleted from a memory. Consequently, the vertex Vtf that cannot be projected onto the terrain object TOJ and the polygon including the vertex Vtf may be set not to be displayed.

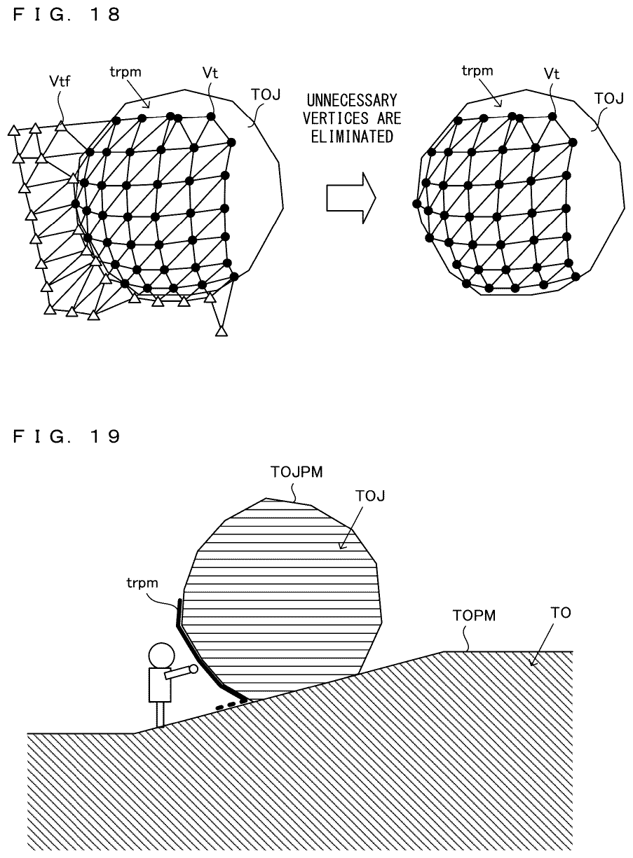

FIG. 18 is a diagram showing an example of the trace polygon mesh trpm before and after unnecessary vertices are eliminated in a case where the trace polygon mesh trpm is projected onto the terrain object TOJ.

As shown in FIG. 18, the vertex Vtf (a point indicated by a white triangle) is an unnecessary vertex that cannot be projected onto the terrain object TOJ, and the vertex Vt (a point indicated by a black circle) is a vertex projected onto the terrain object TOJ. If the unnecessary vertex Vtf is eliminated after the projection, as shown in the right diagram of FIG. 18, the trace polygon mesh trpm sticks to the terrain object TOJ, and a part of the trace polygon mesh trpm is not displayed on a portion other than the terrain object TOJ. Consequently, if the destruction action hits the terrain object TOJ, it is possible to leave the trace tr only on the terrain object TOJ at the place hit by the destruction action.

In the exemplary embodiment, a plurality of voxel spaces are set in the virtual space, and a plurality of terrain objects are formed based on voxel data of each voxel space. FIG. 19 is a diagram showing the state where another terrain object TOJ is placed on the terrain object TO, and the player character PC performs the destruction action on the other terrain object TOJ.

To the virtual space, a field voxel space representing the entirety of the field of the game is fixed. Voxel values (specifically, density data and material data) are set in voxel data of each voxel in the field voxel space, thereby forming the terrain object TO (a terrain polygon mesh TOPM representing the surface of the terrain object TO). The player character PC advances the game while moving on the terrain object TO or boring a hole in the terrain object TO by performing the destruction action on the terrain object TO. The terrain object TO is a voxel object fixed to the virtual space, and for example, is an object representing the ground, a slope, or a mountain raised from the ground. Separately from the field voxel space, a second voxel space that can move in the virtual space is set, and voxel values are set in voxel data of each voxel in the second voxel space. Consequently, another terrain object TOJ (a terrain polygon mesh TOJPM representing the surface of the terrain object TOJ) is formed on the terrain object TO. The terrain object TOJ is, for example, a rock placed on the ground.

As shown in FIG. 19, if the destruction action is performed by the player character PC, it is determined which terrain object the destruction action hits. For example, if the destruction action hits the terrain object TOJ defined by the second voxel space, as described above, the trace polygon mesh trpm is projected onto the terrain object TOJ. The vertex Vtf of the trace polygon mesh trpm that cannot be projected onto the terrain object TOJ is eliminated as an unnecessary vertex. Thus, as shown in FIG. 19, in the trace polygon mesh trpm, a portion projected onto the terrain object TOJ (a solid line portion along the terrain object TOJ) is displayed, and a portion projected onto the terrain object TO (a dashed line portion along the terrain object TO) is not displayed. Consequently, the trace tr is displayed only on the surface of the terrain object TOJ hit by the destruction action.

Although not shown in the figures, if the destruction action hits the terrain object TO defined by the field voxel space, the trace polygon mesh trpm is projected onto the terrain object TO. In the trace polygon mesh trpm, a portion projected onto the terrain object TO is displayed, and a portion projected onto a terrain object other than the terrain object TO is not displayed. Consequently, the trace tr is displayed only on the surface of the terrain object TO hit by the destruction action.

That is, in a case where a plurality of terrain objects are present in the virtual space, the trace polygon mesh trpm is projected onto the surface of a terrain object hit by the destruction action, and the trace tr is left on the terrain object.

If the destruction action hits the terrain object TOJ, the trace polygon mesh trpm is placed, and it is determined whether or not a straight line parallel to the direction of the destruction action passing through the vertex Vt intersects the terrain polygon mesh TOJPM. If the straight line parallel to the direction of the destruction action passing through the vertex Vt does not intersect the terrain polygon mesh TOJPM hit by the destruction action, the vertex Vt is treated as a vertex that cannot be projected onto the terrain object TOJ. Here, even if a straight line L parallel to the direction of the destruction action passing through a certain vertex Vts intersects the terrain polygon mesh TOJPM, there may also be a case where the vertex Vts is treated as a vertex that cannot be projected onto the terrain object TOJ. For example, if the intersection point between the straight line L parallel to the direction of the destruction action passing through the vertex Vts and the terrain polygon mesh TOJPM is too far away from the hit position of the destruction action, such a vertex Vts may be treated as a vertex that cannot be projected onto the terrain object TOJ. For example, if such a vertex Vts is projected onto the terrain object TOJ and left as a part of the trace polygon mesh trpm, the trace polygon mesh trpm may have an unnaturally elongated shape. Thus, such a vertex Vts may be treated as a vertex that cannot be projected onto the terrain object TOJ, and may be eliminated from the trace polygon mesh trpm after the projection. Such a vertex Vts may not be eliminated as a vertex that cannot be projected onto the terrain object TOJ.

Next, a description is given of a process in a case where the destruction action is performed on a terrain object on which the trace polygon mesh trpm is placed.

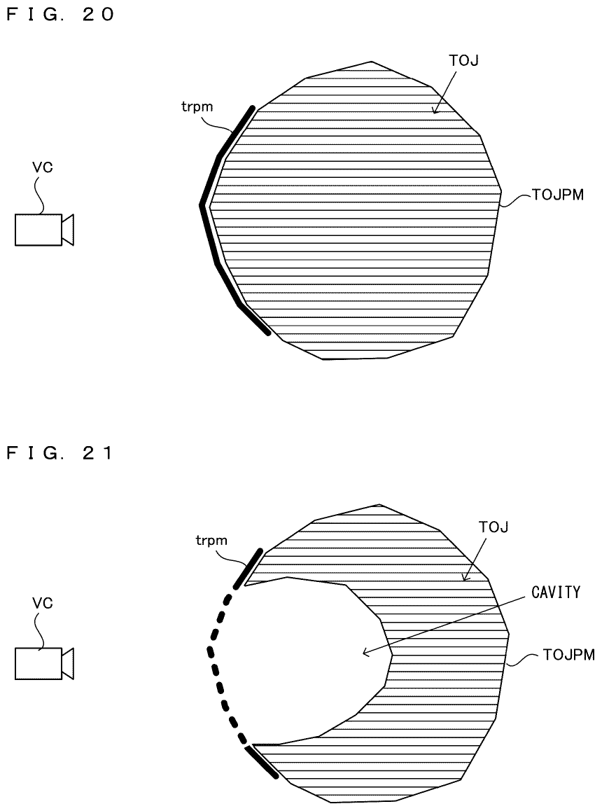

FIG. 20 is a diagram showing the state before the destruction action is performed on the terrain object TOJ on which the trace polygon mesh trpm is placed. FIG. 21 is a diagram showing the state after the destruction action is performed on the terrain object on which the trace polygon mesh trpm is placed. FIGS. 20 and 21 show cross-sectional views of the terrain object TOJ on which the trace polygon mesh trpm is placed. As shown in FIGS. 20 and 21, a virtual camera VC is placed on the left side, and an image of the virtual space viewed from the virtual camera VC is displayed as a game image on a display.

As shown in FIG. 20, if the destruction action is performed on the terrain object TOJ, the trace polygon mesh trpm is placed on the terrain object TOJ before being destroyed. In this case, an image of the virtual space when viewed from the virtual camera VC is an image which is obtained by adding the trace tr onto the terrain object TOJ and in which the terrain object TOJ is cracked.

On the other hand, as shown in FIG. 21, if the destruction action is further performed on the terrain object TOJ on which the trace polygon mesh trpm is placed, and a part of the terrain object TOJ is destroyed, a cavity occurs in the terrain object TOJ. In this case, the trace polygon mesh trpm maintains the same shape as before the destruction, but in the trace polygon mesh trpm, a portion relating to the portion of the terrain object TOJ that is not destroyed is displayed, and a portion relating to the portion of the terrain object TOJ that is destroyed is hidden. Specifically, in the trace polygon mesh trpm, a portion where the terrain object TOJ is present in a predetermined range on the far side as viewed from the virtual camera VC (a solid line portion in FIG. 21) is displayed. On the other hand, in the trace polygon mesh trpm, a portion where the terrain object TOJ is not present in a predetermined range on the far side as viewed from the virtual camera VC (a dashed line portion in FIG. 21) is not displayed. More specifically, when an image is drawn, with respect to each pixel, the depth value of the terrain polygon mesh TOJPM representing the surface of the terrain object TOJ and the depth value of the trace polygon mesh trpm are compared with each other. As a result of the comparison, if the trace polygon mesh trpm is on the near side, and the difference between the depth values is within a predetermined range, the trace polygon mesh trpm on the near side is drawn. If the difference between the depth values is out of the predetermined range, the terrain polygon mesh TOJPM on the far side is drawn. Consequently, an image is displayed in which a hole is bored in a part of the terrain object TOJ, the trace tr in a portion of the hole disappears, and the trace tr is left around the hole.

If the destruction action is further performed on the terrain object TOJ on which the trace polygon mesh trpm is placed, the process of projecting the trace polygon mesh trpm onto the terrain object TOJ after the destruction may be performed again. In this case, when the terrain object TOJ is destroyed, the trace polygon mesh trpm on the terrain object TOJ is deleted, and a plate-shaped trace polygon mesh trpm is newly placed at a start position and projected toward the terrain object TOJ after the destruction. As a result, the solid line portion of the trace polygon mesh trpm shown in FIG. 21 is displayed as the trace tr. The dashed line portion of the trace polygon mesh trpm shown in FIG. 21 is hidden. Consequently, an image similar to that in FIG. 21 is displayed. In this case, a vertex of the trace polygon mesh trpm may be projected onto the surface of the terrain object TOJ in the back of the hole. In this case, the trace polygon mesh trpm is placed along the surface of the terrain object TOJ after the destruction, and has a shape including the solid line portion shown in FIG. 21 (a portion around the hole) and a portion along the surface of the hole (a portion inside the hole). Consequently, the trace tr of the destruction action is left around the hole and inside the hole. In this case, a portion of the trace polygon mesh trpm stuck to the inside of the hole may be hidden. Consequently, it is possible to leave the trace tr only around the hole.

As described above, in the game according to the exemplary embodiment, it is possible to leave the trace of a destruction action on a terrain object. In a case where the trace is left on the terrain object, a case is possible where the shape of the terrain object is examined, and a trace polygon mesh is deformed to match the shape of the terrain object. In such a method, if the shape of the terrain object is complex, the processing cost may increase when the shape is examined. Particularly, in a case where the shape of the terrain object is freely deformed during the game in accordance with an operation of the player, the shape of the terrain object tends to be complex, and the processing may not be completed in time. However, in the method for projecting the trace polygon mesh onto the terrain object and eliminating an unnecessary vertex as described above, it is possible to place on the terrain object the trace polygon mesh to match the shape of the terrain object by a relatively simple calculation. Thus, even if the terrain object changes during the game, it is possible to leave the trace on the terrain object.

### (Details of Game Processing)

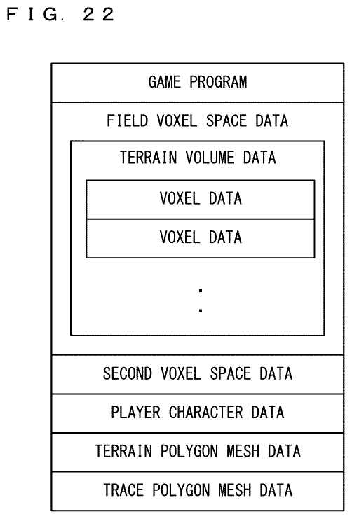

Next, with reference to FIGS. 22 to 25, the details of game processing by the game system 1 are described.

FIG. 22 is a diagram showing examples of various pieces of data used in the game processing by the game system 1. As shown in FIG. 22, the game system 1 stores a game program, field voxel space data, second voxel space data, player character data, terrain polygon mesh data, and trace polygon mesh data.

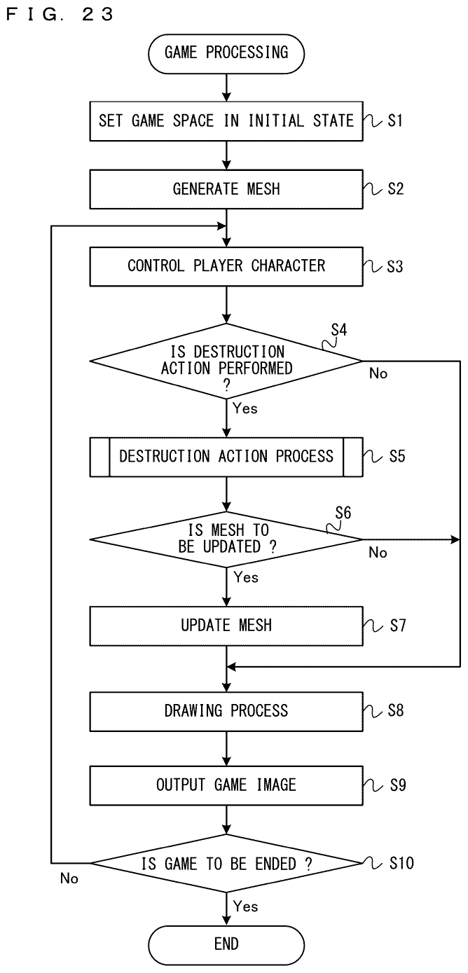

The game program is a program for executing game processing according to the exemplary embodiment (game processing shown in FIG. 23). The game program is stored in advance in a storage medium attached to the slot 23 or the flash memory 84 and is loaded into the DRAM 85 when the game is executed.

The field voxel space data is data regarding the entirety of the field voxel space. The field voxel space data includes terrain volume data. The terrain volume data includes voxel data of each voxel in the field voxel space. The terrain volume data is data for representing a terrain object in the virtual space, and with respect to each voxel included in the field voxel space, holds a voxel value (voxel data) indicating the degree to which an object occupies the inside of a space defined by the voxel. Each piece of voxel data includes density data, material data, and a damage value. A density and a material are set for each voxel in the terrain volume data, and a mesh is generated based on the voxel data, whereby a terrain is formed in the virtual space. In the storage medium attached to the slot 23 or the flash memory 84, the initial terrain volume data is stored in advance. When the game starts, the terrain volume data stored in the storage medium attached to the slot 23 or the flash memory 84 is loaded into the DRAM 85. Consequently, initial terrains are formed. For example, as the initial terrains, a terrain object representing a horizontal ground, a terrain object representing a rock pile, and the like are formed. Each piece of voxel data included in the terrain volume data stored in the DRAM 85 is updated during the execution of the game, whereby the terrain is changed.

The second voxel space data is data regarding the second voxel space placed in the virtual space and different from the field voxel space. The second voxel space data includes second terrain volume data. The second terrain volume data holds a plurality of pieces of voxel data for representing a voxel object that can move in the virtual space (e.g., the terrain object TOJ representing an approximately spherical rock).

The player character data is data regarding the player character PC and includes data indicating the position and the orientation of the player character PC in the virtual space and data (polygon mesh data) indicating the shape of the player character PC.

The terrain polygon mesh data is data indicating a terrain polygon mesh representing the surface of a terrain object. The terrain polygon mesh data includes, for example, data indicating the position of each vertex in the terrain polygon mesh. The terrain polygon mesh data is generated based on the terrain polygon volume data. In a case where a plurality of voxel spaces are placed in the virtual space, and a plurality of terrain objects are placed, the terrain polygon mesh data relating to each terrain object is stored.

The trace polygon mesh data is data regarding a trace polygon mesh and includes data indicating the position of each vertex in the trace polygon mesh, data regarding lines connecting the vertices, and data regarding the opacity of each vertex. In a case where the destruction action is performed at a plurality of places in a terrain object, the trace tr is left at each place. The trace polygon mesh data relating to each trace tr is stored.

In addition to the data shown in FIG. 22, the game system 1 stores various other pieces of data. For example, the game system 1 may store data regarding an enemy character that can move in the virtual space. The enemy character may be a voxel object, or may be a 3D object the shape of which is set in advance by a polygon mesh.

FIG. 23 is a flow chart showing an example of the flow of the game processing executed by the game system 1. The game processing shown in FIG. 23 is started in accordance with, for example, an instruction to start the game given by the player.

In the exemplary embodiment, the description is given on the assumption that the processes of steps shown in FIG. 23 are executed by the processor 81 of the main body apparatus 2 executing the game program. In another exemplary embodiment, however, some of the processes of the above steps may be executed by a processor (e.g., a dedicated circuit or the like) different from the processor 81. Further, in a case where the game system 1 can communicate with another information processing apparatus (e.g., a server), some of the processes of the steps shown in FIG. 23 may be executed by the other information processing apparatus. The processes of all of the steps shown in FIG. 23 are merely illustrative. Thus, the processing order of the steps may be changed, or another process may be performed in addition to (or instead of) the processes of all of the steps, so long as similar results are obtained.

The processor 81 executes the processes of steps shown in FIG. 23 using a memory (e.g., the DRAM 85). That is, the processor 81 stores information obtained in the processing steps in the memory, and if the information is used in the subsequent processing steps, reads the information from the memory and uses the information.

As shown in FIG. 23, in step S1, the processor 81 sets the virtual space in an initial state. Specifically, the processor 81 acquires from the storage medium attached to the slot 23 the terrain volume data indicating a terrain in the virtual space in the initial state and stores a part or the entirety of the acquired terrain volume data in the DRAM 85. The processor 81 also reads the player character data from the above storage medium, sets the initial position and the orientation of the player character, and stores the initial position and the orientation in the DRAM 85. The processor 81 also sets the initial position and the orientation of the virtual camera and stores the initial position and the orientation in the DRAM 85.

The voxel data stored in the DRAM 85 may be voxel data of the entire range of the virtual space, or may be voxel data of a partial range of the virtual space used to generate a game image. The processor 81 may generate an image of an object using, for example, pieces of voxel data of voxels included in a partial range (e.g., a range within a predetermined distance from the position of the virtual camera) of the virtual space. If voxel data regarding the partial range of the virtual space is written, a process similar to that of the above step S1 is executed at an appropriate timing during the execution of the series of processes of steps S2 to S10 (e.g., the timing when the position of the virtual camera moves by a predetermined distance or more).

In step S2, the processor 81 generates a mesh regarding each voxel object. Specifically, the processor 81 generates a terrain polygon mesh regarding a terrain object based on the terrain volume data (the terrain volume data of the above field voxel space data, the second terrain volume data, or the like). The terrain polygon mesh is generated in accordance with the method described in the above “[2-2. Mesh]”. The processor 81 also generates a mesh regarding a voxel object other than the terrain object by a similar method. After step S2, the game is started, and the processes of steps S3 to S10 are repeatedly executed at predetermined frame time intervals (e.g., 1/60-second intervals) during the game.

In step S3, the processor 81 controls the action of the player character PC. For example, based on operation data received from the controllers 3 and 4, the processor 81 moves the player character PC and causes the player character PC to perform a destruction action or jump. The destruction action of the player character PC may be a plurality of destruction actions such as a punch, a kick, the throwing of a rock, and the shooting of a bullet. After step S3, the process of step S4 is executed.

In step S4, the processor 81 determines whether or not the destruction action is performed by the player character PC. For example, the processor 81 determines whether or not a predetermined button of a controller is pressed. If the result of the determination in step S4 is affirmative, the process of step S5 is executed. If, on the other hand, the result of the determination in step S4 is negative, the process of step S8 is executed.

In step S5, the processor 81 performs a destruction action process. Here, first, it is determined whether or not the destruction action of the player character PC hits the terrain object. If the destruction action hits the terrain object, the terrain object is destroyed, or the trace tr is added to the terrain object. The details of the destruction action process in step S5 will be described below. Next, the processor 81 executes the process of step S6.

In step S6, the processor 81 determines whether or not the mesh is to be updated. Here, if the destruction action hits the terrain object in step S5, and the terrain object is destroyed (the voxel data is updated), the processor 81 determines that the terrain polygon mesh is to be updated. If the result of the determination in step S6 is affirmative, the process of step S7 is executed. If, on the other hand, the result of the determination in step S6 is negative, the process of step S8 is executed.

In step S7, the processor 81 updates the mesh. Specifically, the processor 81 updates the terrain polygon mesh regarding the terrain object the voxel data of which is changed in step S5. Consequently, based on the updated voxel data, the vertex positions of the terrain polygon mesh are recalculated. The updated terrain polygon mesh is stored as the terrain polygon mesh data in the DRAM 85. After step S7, the process of step S8 is executed.

In step S8, the processor 81 performs a drawing process, thereby generating an image (a game image) of the virtual space viewed from the virtual camera. Here, using texture images relating to polygon meshes (a terrain polygon mesh, a trace polygon mesh, a polygon mesh representing the player character PC, and the like), the processor 81 draws each polygon mesh. With respect to each type of terrain (each type of material), the game system 1 stores a terrain texture image representing the terrain and a trace texture image representing a trace. For example, if the destruction action hits a rock terrain, a terrain polygon mesh is drawn using the terrain texture image representing the rock terrain, and a trace polygon mesh is also drawn using the trace texture image relating to the rock terrain (an image in which a rock is cracked). Specifically, regarding each polygon mesh, the processor 81 calculates the depth value of each pixel (a value indicating a position in the image capturing direction of the virtual camera) and draws the polygon mesh if the calculated depth value is small. Here, in a case where the trace polygon mesh is drawn, the processor 81 draws a portion where the terrain polygon mesh is present in a predetermined range on the far side of the virtual camera, and does not draw a portion where the terrain polygon mesh is not present in the predetermined range on the far side of the virtual camera. Consequently, if the destruction action hits the terrain object, the trace tr is displayed at the place hit by the destruction action. If the terrain object on the surface of which the trace polygon mesh is placed is destroyed, the trace tr is displayed around the destroyed portion, and the trace tr disappears from the destroyed portion. In this case, the terrain polygon mesh inside the destroyed portion is drawn. After step S8, the process of step S9 is executed.

In step S9, the processor 81 outputs the game image generated in step S8 to the display. After step S9, the process of step S10 is executed.

In step S10, the processor 81 determines whether or not the game is to be ended. For example, the processor 81 determines whether or not an instruction to end the game is given by the user. If the result of the determination in step S10 is negative, the process of step S3 is executed again. From this point onward, the series of processes of steps S3 to S10 are repeatedly executed until it is determined in step S10 that the game is to be ended. If, on the other hand, the result of the determination in step S10 is affirmative, the processor 81 ends the game processing shown in FIG. 23.

### (Destruction Action Process)

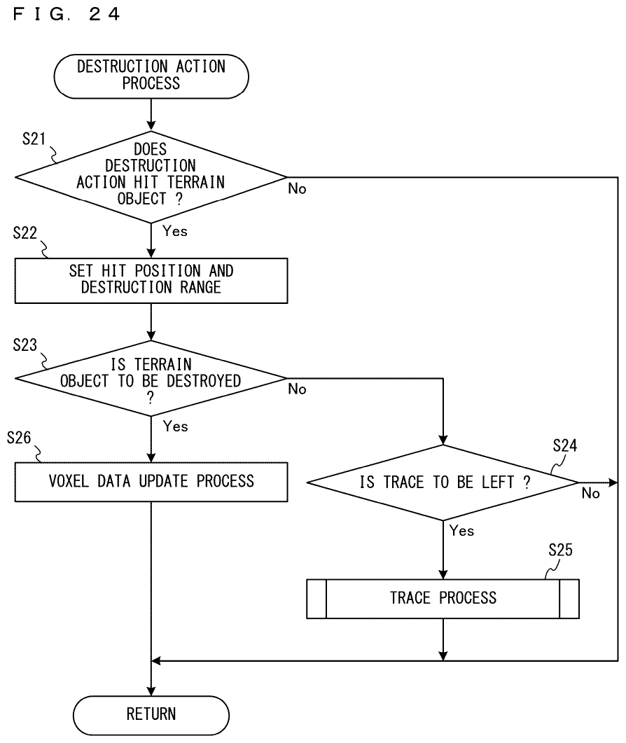

With reference to FIG. 24, the details of the destruction action process in step S5 are described below. FIG. 24 is a flow chart showing an example of the destruction action process in step S5.

In step S21, the processor 81 determines whether or not the destruction action hits the terrain object. Specifically, based on the terrain polygon mesh representing the shape of the terrain object, the position of the player character PC, and the direction of the destruction action, the processor 81 determines whether or not the destruction action hits the terrain object. For example, using a collision determination object, the processor 81 determines whether or not the destruction action hits the terrain object. For example, the processor 81 flies the collision determination object by a predetermined distance from the position of the player character PC in the direction of the destruction action and determines whether or not the collision determination object collides with the terrain polygon mesh. As the terrain polygon mesh representing the shape of the terrain object, a collision determination terrain polygon mesh for determining whether or not the destruction action hits the terrain object and a display terrain polygon mesh for displaying a terrain (generating a game image) are prepared. Here, using the collision determination terrain polygon mesh, the processor 81 determines whether or not the destruction action hits the terrain object. The collision determination terrain polygon mesh represents the shape of the terrain object and is coarser than the display terrain polygon mesh. Using the collision determination terrain polygon mesh, it is possible to reduce the processing load related to the collision determination regarding whether or not the destruction action hits the terrain object. The collision determination terrain polygon mesh and the display terrain polygon mesh may be the same as each other. That is, a single terrain polygon mesh representing the shape of the terrain object may be prepared, and the collision determination and the drawing process may be performed based on the terrain polygon mesh. If the determination is YES in step S21, next, the processor 81 executes the process of step S22. If the determination is NO in step S21, the processor 81 ends the process shown in FIG. 24.

In step S22, the processor 81 sets the hit position of the destruction action and also sets a destruction range. Specifically, first, based on the terrain polygon mesh, the position of the player character PC, and the direction of the destruction action, the processor 81 sets the hit position. Next, the processor 81 sets a predetermined destruction range including the hit position. The destruction range indicates a range in a case where the terrain object is destroyed. The destruction range has a shape set in advance, and for example, may be a sphere, a column, a cone, an ellipsoid, a shape obtained by asymmetrically deforming an ellipsoid in the left-right direction, or the like. The size and/or the shape of the destruction range may differ in accordance with the type of the terrain object, the type of the destruction action, or the like. After the process of step S22, the processor 81 executes the process of step S23.

In step S23, the processor 81 determines whether or not the terrain object hit by the destruction action is to be destroyed. If a destruction condition is satisfied, the processor 81 determines that the terrain object is to be destroyed. The destruction condition is a condition based on the type of the destruction action, the material of the terrain object included in the destruction range, and the number of times the destruction action hits the terrain object included in the destruction range. For example, if the terrain object is set to be destroyed in a case where the destruction action hits the terrain object three times, the destruction condition is satisfied by the hit of the third destruction action. Specifically, a damage value is stored for each voxel of the terrain object, and if the destruction action hits the terrain object, a value is added to the damage value of each voxel included in the destruction range. Then, if the damage value exceeds a predetermined value, the voxel is destroyed. If the determination is YES in step S23, next, the processor 81 executes the process of step S26. If the determination is NO in step S23, next, the processor 81 executes the process of step S24.

In step S24, the processor 81 determines whether or not a trace is to be left on the terrain object. For example, there are a case where the trace is left and a case where the trace is not left, depending on the relationship between the type of the destruction action and the type of the terrain object (the type of the material). There are also a case where the trace is left and a case where the trace is not left, depending on the number of times the destruction action hits the terrain object. Based on these cases, the processor 81 determines whether or not the trace is to be left on the terrain object. For example, in a case where the type of the destruction action is a punch, and the type of the terrain object (the type of the material) is a rock, and if the destruction action hits the terrain object twice, it is determined that the trace is to be left. If the determination is YES in step S24, next, the processor 81 executes the process of step S25. If the determination is NO in step S24, the processor 81 ends the process shown in FIG. 24. If it is not determined in step S24 that the trace is to be left, the processor 81 may change a texture image of the terrain object in a predetermined range including the hit position. For example, if the destruction action hits the terrain object once, the texture image of the terrain object may be changed without placing a trace polygon mesh on the terrain object in a trace process to be performed next. In this case, it is possible to change the display form (e.g., the color) of the terrain object without adding the trace polygon mesh to the terrain object. If, on the other hand, the destruction action hits the terrain object twice, the determination may be YES in step S24, and the trace polygon mesh may be placed on the terrain object in the trace process to be performed next.

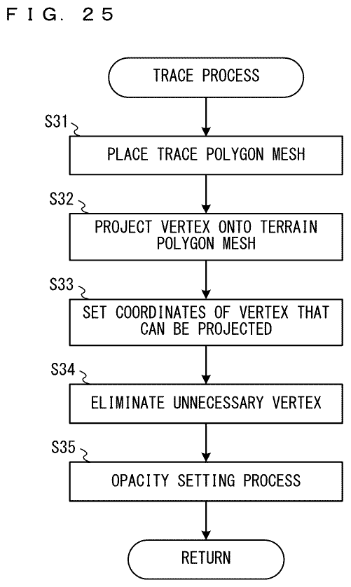

In step S25, the processor 81 executes a trace process for leaving the trace on the terrain object hit by the destruction action. With reference to FIG. 25, the details of the trace process in step S25 are described below. FIG. 25 is a flow chart showing an example of the trace process in step S25.

### (Trace Process)

In step S31, first, the processor 81 places the trace polygon mesh trpm in the virtual space. Specifically, the processor 81 places a plate-shaped trace polygon mesh trpm at a start position based on the position of the player character PC so that the trace polygon mesh trpm is perpendicular to the direction of the destruction action. The start position (the initial position) where the trace polygon mesh trpm is placed may be slightly behind the player character PC, or may be the position of the player character PC. The start position where the trace polygon mesh trpm is placed may be in front of the player character PC. After step S31, the process of step S32 is performed.

In step S32, the processor 81 projects each vertex of the trace polygon mesh trpm onto the terrain polygon mesh hit by the destruction action. Specifically, the processor 81 extends a straight line from the position of each vertex of the trace polygon mesh trpm placed at the start position in the direction of the destruction action and determines whether or not the straight line and the terrain polygon mesh intersect each other. If the straight line and the terrain polygon mesh intersect each other, the processor 81 calculates the coordinates of the intersection point. After step S32, the process of step S33 is performed.

In step S33, the processor 81 sets the coordinates of the vertex of the trace polygon mesh trpm projected onto the terrain polygon mesh in the process of step S32. Specifically, based on the intersection point calculated in step S32, the processor 81 sets the coordinates of the vertex. For example, the processor 81 sets the coordinates of a position closer to the virtual camera than the intersection point is as the coordinates of the vertex of the trace polygon mesh trpm after the projection. After step S33, the process of step S34 is performed.

In step S34, the processor 81 eliminates an unnecessary vertex. Here, if the above intersection point cannot be calculated in the process of step S32, e.g., if the vertex of the trace polygon mesh trpm cannot be projected onto the terrain polygon mesh hit by the destruction action, the processor 81 eliminates the vertex (the vertex Vtf in FIG. 17) as an unnecessary vertex. Specifically, the processor 81 sets the vertex Vtf that cannot be projected onto the terrain polygon mesh not to be displayed. For example, the processor 81 may set the vertex Vtf to be transparent, or may set the vertex Vtf not to be connected to another vertex. Consequently, a polygon including the eliminated vertex is not displayed. After step S34, the process of step S35 is performed.

In step S35, the processor 81 performs the process of setting the opacity of each vertex of the trace polygon mesh trpm after the projection. Specifically, the processor 81 sets the opacity of each vertex (the vertex Vt2 in FIG. 17) of the trace polygon mesh trpm projected onto the terrain polygon mesh to a predetermined value (e.g., a maximum value). The processor 81 sets the opacity of a vertex (the vertex Vt1 in FIG. 17) in contact with the polygon including the vertex eliminated in step S34 to a value smaller than the predetermined value. If the process of step S35 is executed, the processor 81 ends the process shown in FIG. 25 and returns to the process in FIG. 24.

Referring back to FIG. 24, if the process of step S25 is executed, the processor 81 ends the process shown in FIG. 24.

On the other hand, in step S26, the processor 81 performs a voxel data update process. Specifically, the processor 81 stores a value indicating that the terrain object is not present in voxel data of a voxel included in the destruction range. For example, the processor 81 sets the density of a voxel in the destruction range to “0”. Consequently, the terrain object included in the destruction range is destroyed. The process of step S7 is executed based on the updated voxel data, thereby updating the shape of the terrain object.

The processes shown in the above flow charts are merely illustrative, and the order and the contents of the processes, and the like may be appropriately changed.

As described above, in the exemplary embodiment, if a destruction action hits a terrain object, a trace polygon mesh is projected toward the terrain object at the place hit by the destruction action. The coordinates of a vertex that can be projected onto the terrain object are set based on the position onto which the vertex is projected (the intersection point calculated in step S32), and a polygon including a vertex that cannot be projected onto the terrain object is set not to be displayed. Then, a trace texture is applied onto the trace polygon mesh placed on the terrain object, and a drawing process is performed. Consequently, it is possible to leave the trace of the destruction action on the terrain object at the place hit by the destruction action. For example, it is possible to leave the trace in a range wider than a destruction range including the hit position of the destruction action (a range on the surface of the terrain object wider than the surface of the terrain object included in the destruction range). It is also possible to reduce the processing cost while leaving the trace of the destruction action on a complex terrain.

In the exemplary embodiment, the trace polygon mesh is projected from a start position based on the position of a player character in the direction of the destruction action. Consequently, it is possible to project the trace polygon mesh in accordance with the direction of the destruction action at the place where the destruction action is performed, and leave the trace of the destruction action on the terrain object.

In the exemplary embodiment, even after the terrain object is destroyed by the destruction action, a part of the trace polygon mesh is displayed. Consequently, even after the terrain object is destroyed, it is possible to leave the trace of the hit of the destruction action.

In the exemplary embodiment, in a case where the terrain object on the surface of which the trace polygon mesh is placed is destroyed, the trace polygon mesh itself is not destroyed, and a part of the trace polygon mesh is not displayed. That is, even if the terrain object is destroyed, the trace polygon mesh itself maintains a shape along the surface of the terrain object before the destruction without deleting each vertex of the trace polygon mesh or changing the position of each vertex. Then, in the drawing process, a pixel of the trace polygon mesh relating to the portion of the terrain object that is destroyed is not displayed. Specifically, in the drawing process for drawing the trace polygon mesh, a portion of the trace polygon mesh where the terrain object is not present on the far side in a predetermined range is not drawn, and a portion of the trace polygon mesh where the terrain object is present on the far side in the predetermined range is drawn. Consequently, it is possible to reduce the processing cost while representing the state where the terrain object on the surface of which the trace polygon mesh is placed is destroyed. For example, a case is also possible where a vertex of the trace polygon mesh relating to the portion of the terrain object that is destroyed is deleted, thereby changing the shape itself of the trace polygon mesh. In this case, it may be necessary to calculate the shape of the portion of the trace polygon mesh to be deleted, and it may increase the processing cost. In the above exemplary embodiment, however, even if the terrain object as a voxel object is destroyed, the trace polygon mesh itself is not destroyed, and in the drawing process, a portion of the trace polygon mesh relating to the portion of the terrain object that is destroyed is hidden. Thus, it is possible to reduce the processing cost.

### (Variations)

While the exemplary embodiment has been described above, the exemplary embodiment is merely an example and may be modified as follows, for example.

For example, in the above exemplary embodiment, the destruction action is performed using a part (specifically, an arm portion) of the player character PC. In another exemplary embodiment, the player character PC may perform any other destruction action. For example, in another exemplary embodiment, the destruction action performed by the player character PC may be performed using the entirety of the player character PC. The destruction action performed by the player character PC may not be performed using at least a part of the player character PC. For example, the destruction action may be performed by the player character PC throwing a predetermined object. If the predetermined object thrown by the player character PC hits a terrain object, this may mean that the destruction action hits the terrain object, and a trace may be left on the terrain object. If the predetermined object thrown by the player character PC hits the terrain object, the terrain object may be destroyed.

In the above exemplary embodiment, the player character PC is caused to perform the destruction action for destroying the terrain object. In another exemplary embodiment, the player character PC may be caused to perform an action for adding the terrain object. For example, the player character PC may be caused to perform the action of piling up soil or the action of piling up blocks. Then, if the action for adding the terrain hits the terrain object (e.g., if the soil is piled up or the blocks are piled up on the ground), the terrain may be added. The player character PC may be caused to perform the action of bending the terrain object. That is, the player character PC may be caused to perform a deformation action for deforming (adding, destroying, or bending) the terrain object. If the deformation action hits the terrain object, a deformation range is set based on the position hit by the deformation action, and the voxel value of a voxel included in the deformation range is updated, thereby deforming the terrain object. Also in such a case, the above trace polygon mesh may be projected onto the terrain object, whereby the trace of the destruction action may be left on the terrain object at the place hit by the deformation action.

In the above exemplary embodiment, if the deformation action hits the terrain object, a plate-shaped trace polygon mesh is initially placed in the virtual space and projected onto the terrain object. The shape of the trace polygon mesh to be initially placed is not limited to the plate-like shape, and may be any shape.

In the above exemplary embodiment, the player character PC is caused to perform the deformation action (e.g., the destruction action), and if the deformation action hits the terrain object, the trace is left on the terrain object. In another exemplary embodiment, not only in a case where the player character PC is caused to perform the deformation action, but also in a case where any deformation event for deforming the terrain object occurs, the trace may be left on the terrain object. The deformation event may be, for example, the action of the player character PC, or may be an event that occurs regardless of the player character PC. For example, the deformation event may be an event where a predetermined object (e.g., a meteor) falls from the sky, an event where an enemy character throws a predetermined object, or an event where a terrain changes if a predetermined time arrives. That is, “the deformation event occurs” may include the state where the deformation action of the player character PC hits the terrain object, the state where another object hits the terrain object regardless of the player character PC, the state where a predetermined time arrives regardless of the player character PC, and the like.

In the above exemplary embodiment, the terrain object is a voxel object, and a terrain polygon mesh representing the surface of the terrain object is generated based on voxel data. In another exemplary embodiment, the terrain object may not be a voxel object, and may be a 3D object the shape of which is set based on polygon data prepared in advance. In this case, the terrain polygon mesh representing the surface of the terrain object is stored in advance and deformed in accordance with the fact that the deformation action occurs. A trace polygon mesh is projected onto the terrain polygon mesh at the place where the deformation action occurs, and the coordinates of a vertex that can be projected onto the terrain polygon mesh based on the position onto which the vertex is projected is set. A polygon including a vertex that cannot be projected onto the terrain polygon mesh is set not to be displayed. Consequently, the trace polygon mesh is placed on the terrain polygon mesh. Then, the terrain polygon mesh is drawn, and the trace polygon mesh is drawn.

In the above exemplary embodiment, the density of a voxel in the destruction range (an example of the deformation range) is set to “0”, thereby setting a value indicating that an object is not present in the voxel. Consequently, a portion in the destruction range in a voxel object is erased, and the voxel object is destroyed. The destruction (erasure) of the voxel object may be set not only by setting the density of voxel data to “0”, but also by setting the density to another value. For example, regarding the density, “a value indicating that an object is not present” may not be limited to “0”, and may be any value less than a reference value (e.g., 128). Regarding the density, “a value indicating that an object is present” may be a value in the range from 1 to 255, or may be a value greater than or equal to the reference value. The destruction of a voxel object may be performed not only by changing the density of voxel data, but also by another method. For example, a flag indicating the presence or absence of an object may be stored in voxel data, and if the flag is set to ON, it may be indicated that an object is present in the voxel. If the flag is set to OFF, it may be indicated that an object is not present in the voxel (e.g., a cavity).

The above processes may be executed not only by the game system 1 but also by any other information processing apparatus or information processing system. The information processing system may include a plurality of apparatuses, and the plurality of apparatuses may be connected together via a network (e.g., a LAN, the Internet, or the like).

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors of an information processing apparatus to execute image processing comprising:
storing, in a memory,
terrain volume data that is data for representing a terrain object in a virtual space, and with respect to each voxel included in a voxel space placed in the virtual space, holds a voxel value indicating a degree to which an object occupies inside of a space defined by the voxel, and
terrain polygon mesh data generated based on the terrain volume data and indicating a terrain polygon mesh representing a surface of the terrain object;
based on an operation input of a player, causing a player character to perform a deformation action for deforming the terrain object in the virtual space;
if the deformation action hits the terrain object,
updating the voxel value of a voxel included in a deformation range set based on a position hit by the deformation action, and
in accordance with the update of the voxel value, updating the terrain polygon mesh data;
projecting a trace polygon mesh toward the terrain polygon mesh at a place where the deformation action hits the terrain object, and regarding vertices included in the trace polygon mesh, setting coordinates of a vertex that can be projected onto the terrain polygon mesh based on a position onto which the trace polygon mesh is projected and also setting a polygon including a vertex that cannot be projected onto the terrain polygon mesh not to be displayed, thereby placing the trace polygon mesh on the terrain polygon mesh; and
generating an image of the virtual space by a drawing process including drawing of the terrain polygon mesh or a display terrain polygon mesh generated separately from the terrain polygon mesh and for displaying the surface of the terrain object, and drawing of the trace polygon mesh using a trace texture representing a trace of the deformation action.

2. The one or more non-transitory computer-readable media according to claim 1, wherein
the deformation action is a destruction action for destroying the terrain object, and
the image processing further comprises
if the destruction action hits the terrain object, updating the voxel value of a voxel included in the deformation range to a value indicating that the terrain object is not present.

3. The one or more non-transitory computer-readable media according to claim 2, wherein
the destruction action is an action performed toward a specified direction from the player character, and
the image processing further comprises
projecting the trace polygon mesh from a start position based on a position of the player character in a direction in which the destruction action is performed, thereby performing the projection at a place hit by the destruction action.

4. The one or more non-transitory computer-readable media according to claim 2, wherein
the image processing further comprises
in the drawing of the trace polygon mesh, not drawing a portion where the terrain object is not present in a predetermined range on a far side of the trace polygon mesh, and drawing a portion where the terrain object is present in the predetermined range.

5. The one or more non-transitory computer-readable media according to claim 2, wherein
the image processing further comprises
if the destruction action is further performed on the terrain object on which the trace polygon mesh is placed, projecting the trace polygon mesh toward the terrain polygon mesh again, and setting coordinates of a vertex that can be projected onto the terrain polygon mesh based on a position onto which the trace polygon mesh is projected and also setting a polygon including a vertex that cannot be projected onto the terrain polygon mesh not to be displayed, thereby placing the trace polygon mesh on the terrain polygon mesh.

6. The one or more non-transitory computer-readable media according to claim 1, wherein
the image processing further comprises
among the vertices included in the trace polygon mesh, setting an opacity of a vertex in contact with the polygon set not to be displayed so that the opacity is lower than an opacity of another vertex that can be projected onto the terrain polygon mesh.

7. The one or more non-transitory computer-readable media according to claim 1, wherein
the image processing further comprises
based on the voxel value, generating the terrain polygon mesh by an algorithm for placing a polygon so that a vertex position of the terrain polygon mesh is determined between a voxel in which the terrain object is not present and a voxel in which the terrain object is present, and
based on the hit of the deformation action, recalculating a vertex position of the terrain polygon mesh in a range at least including a voxel the voxel value of which is updated.

8. One or more non-transitory computer-readable media having stored therein instructions that, when executed, cause one or more processors of an information processing apparatus to execute image processing comprising:
storing, in a memory, terrain polygon mesh data indicating a terrain polygon mesh representing a surface of a terrain object in a virtual space;
causing a deformation event where the terrain object is deformed in the virtual space to occur;
based on the occurrence of the deformation event, deforming the terrain polygon mesh;
projecting a trace polygon mesh toward the terrain polygon mesh at a place where the deformation event occurs, and regarding vertices included in the trace polygon mesh, setting coordinates of a vertex that can be projected onto the terrain polygon mesh based on a position onto which the trace polygon mesh is projected and also setting a polygon including a vertex that cannot be projected onto the terrain polygon mesh not to be displayed, thereby placing the trace polygon mesh on the terrain polygon mesh; and
generating an image of the virtual space by a drawing process including drawing of the terrain polygon mesh or a display terrain polygon mesh generated separately from the terrain polygon mesh and for displaying the surface of the terrain object, and drawing of the trace polygon mesh using a trace texture representing a trace of the deformation event.

9. The one or more non-transitory computer-readable media according to claim 8, wherein
the image processing further comprises
if the deformation event occurs again in the terrain object on which the trace polygon mesh is placed, deforming the terrain polygon mesh, leaving a portion of the trace polygon mesh relating to a portion of the terrain polygon mesh that is not deformed, and controlling a portion of the trace polygon mesh relating to the deformed portion of the terrain polygon mesh not to be displayed.

10. An information processing system comprising: one or more processors that are configured to execute image processing comprising:
storing, in a memory,
terrain volume data that is data for representing a terrain object in a virtual space, and with respect to each voxel is included in a voxel space placed in the virtual space, holds a voxel value indicating a degree to which an object occupies inside of a space defined by the voxel, and
terrain polygon mesh data generated based on the terrain volume data and indicating a terrain polygon mesh representing a surface of the terrain object,
based on an operation input of a player, causing a player character to perform a deformation action for deforming the terrain object in the virtual space;
if the deformation action hits the terrain object,
updating the voxel value of a voxel included in a deformation range set based on a position hit by the deformation action, and
in accordance with the update of the voxel value, updating the terrain polygon mesh data;
projecting a trace polygon mesh toward the terrain polygon mesh at a place where the deformation action hits the terrain object, and regarding vertices included in the trace polygon mesh, setting coordinates of a vertex that can be projected onto the terrain polygon mesh based on a position onto which the trace polygon mesh is projected and also setting a polygon including a vertex that cannot be projected onto the terrain polygon mesh not to be displayed, thereby placing the trace polygon mesh on the terrain polygon mesh; and
generating an image of the virtual space by a drawing process including drawing of the terrain polygon mesh or a display terrain polygon mesh generated separately from the terrain polygon mesh and for displaying the surface of the terrain object, and drawing of the trace polygon mesh using a trace texture representing a trace of the deformation action.

11. The information processing system according to claim 10, wherein
the deformation action is a destruction action for destroying the terrain object, and
the image processing further comprises
if the destruction action hits the terrain object, updating the voxel value of a voxel included in the deformation range to a value indicating that the terrain object is not present.

12. The information processing system according to claim 11, wherein
the destruction action is an action performed toward a specified direction by the player character, and
the image processing further comprises
projecting the trace polygon mesh from a start position based on a position of the player character in a direction in which the destruction action is performed, thereby performing the projection at a place hit by the destruction action.

13. The information processing system according to claim 11, wherein
the image processing further comprises
in the drawing of the trace polygon mesh, not drawing a portion where the terrain object is not present in a predetermined range on a far side of the trace polygon mesh, and drawing a portion where the terrain object is present in the predetermined range.

14. The information processing system according to claim 11, wherein
the image processing further comprises
if the destruction action is further performed on the terrain object on which the trace polygon mesh is placed, projecting the trace polygon mesh toward the terrain polygon mesh again, and setting coordinates of a vertex that can be projected onto the terrain polygon mesh based on a position onto which the trace polygon mesh is projected and also setting a polygon including a vertex that cannot be projected onto the terrain polygon mesh not to be displayed, thereby placing the trace polygon mesh on the terrain polygon mesh.

15. The information processing system according to claim 10, wherein
the image processing further comprises
among the vertices included in the trace polygon mesh, setting an opacity of a vertex in contact with the polygon set not to be displayed so that the opacity is lower than an opacity of another vertex that can be projected onto the terrain polygon mesh.

16. The information processing system according to claim 10, wherein
the image processing further comprises
based on the voxel value, generating the terrain polygon mesh by an algorithm for placing a polygon so that a vertex position of the terrain polygon mesh is determined between a voxel in which the terrain object is not present and a voxel in which the terrain object is present, and
based on the hit of the deformation action, recalculating a vertex position of the terrain polygon mesh in a range at least including a voxel the voxel value of which is updated.

17. An information processing system comprising: one or more processors that are configured to execute image processing comprising:
storing, in a memory, terrain polygon mesh data indicating a terrain polygon mesh representing a surface of a terrain object in a virtual space;
causing a deformation event where the terrain object is deformed in the virtual space to occur;
based on the occurrence of the deformation event, deforming the terrain polygon mesh;
projecting a trace polygon mesh toward the terrain polygon mesh at a place where the deformation event occurs, and regarding vertices included in the trace polygon mesh, setting coordinates of a vertex that can be projected onto the terrain polygon mesh based on a position onto which the trace polygon mesh is projected and also setting a polygon including a vertex that cannot be projected onto the terrain polygon mesh not to be displayed, thereby placing the trace polygon mesh on the terrain polygon mesh; and
generating an image of the virtual space by a drawing process including drawing of the terrain polygon mesh or a display terrain polygon mesh generated separately from the terrain polygon mesh and for displaying the surface of the terrain object, and drawing of the trace polygon mesh using a trace texture representing a trace of the deformation event.

18. The information processing system according to claim 17, wherein
the image processing further comprises
if the deformation event occurs again in the terrain object on which the trace polygon mesh is placed, deforming the terrain polygon mesh, leaving a portion of the trace polygon mesh relating to a portion of the terrain polygon mesh that is not deformed, and controlling a portion of the trace polygon mesh relating to the deformed portion of the terrain polygon mesh not to be displayed.

19. An information processing apparatus comprising: one or more processors that execute image processing comprising:
storing, in a memory,
terrain volume data that is data for representing a terrain object in a virtual space, and with respect to each voxel is included in a voxel space placed in the virtual space, holds a voxel value indicating a degree to which an object occupies inside of a space defined by the voxel, and
terrain polygon mesh data generated based on the terrain volume data and indicating a terrain polygon mesh representing a surface of the terrain object;
based on an operation input of a player, causing a player character to perform a deformation action for deforming the terrain object in the virtual space;
if the deformation action hits the terrain object,
updating the voxel value of a voxel included in a deformation range set based on a position hit by the deformation action, and
in accordance with the update of the voxel value, updating the terrain polygon mesh data;
projecting a trace polygon mesh toward the terrain polygon mesh at a place where the deformation action hits the terrain object, and regarding vertices included in the trace polygon mesh, setting coordinates of a vertex that can be projected onto the terrain polygon mesh based on a position onto which the trace polygon mesh is projected and also setting a polygon including a vertex that cannot be projected onto the terrain polygon mesh not to be displayed, thereby placing the trace polygon mesh on the terrain polygon mesh; and
generating an image of the virtual space by a drawing process including drawing of the terrain polygon mesh or a display terrain polygon mesh generated separately from the terrain polygon mesh and for displaying the surface of the terrain object, and drawing of the trace polygon mesh using a trace texture representing a trace of the deformation action.

20. An information processing method executed using a processor, the information processing method comprising:
storing, in a memory,
terrain volume data that is data for representing a terrain object in a virtual space, and with respect to each voxel is included in a voxel space placed in the virtual space, holds a voxel value indicating a degree to which an object occupies inside of a space defined by the voxel, and
terrain polygon mesh data generated based on the terrain volume data and indicating a terrain polygon mesh representing a surface of the terrain object;
based on an operation input of a player, causing a player character to perform a deformation action for deforming the terrain object in the virtual space;
if the deformation action hits the terrain object,
updating the voxel value of a voxel included in a deformation range set based on a position hit by the deformation action, and
in accordance with the update of the voxel value, updating the terrain polygon mesh data;
projecting a trace polygon mesh toward the terrain polygon mesh at a place where the deformation action hits the terrain object, and regarding vertices included in the trace polygon mesh, setting coordinates of a vertex that can be projected onto the terrain polygon mesh based on a position onto which the trace polygon mesh is projected and also setting a polygon including a vertex that cannot be projected onto the terrain polygon mesh not to be displayed, thereby placing the trace polygon mesh on the terrain polygon mesh; and
generating an image of the virtual space by a drawing process including drawing of the terrain polygon mesh or a display terrain polygon mesh generated separately from the terrain polygon mesh and for displaying the surface of the terrain object, and drawing of the trace polygon mesh using a trace texture representing a trace of the deformation action.
